(19) United States
(12) Patent Application Publication
(10) Pub. No.: US 2024/0097331 A1
(43) Pub. Date: Mar. 21, 2024

(54) ANTENNA ARCHITECTURE FOR MOBILE DEVICES

(71) Applicant: Meta Platforms Technologies, LLC, Menlo Park, CA (US)

(72) Inventors: Nil Apaydin, Kirkland, WA (US); Fengyu Ge, Monroe, WA (US); Javier Rodriguez De Luis, Kirkland, WA (US); Gordon Michael Coutts, Woodinville, WA (US); Meijiao Li, San Diego, CA (US); Liang Han, Sunnyvale, CA (US); Navid Barani Lonbani, Bellevue, WA (US); Vignesh Manohar, Toronto (CA)

(21) Appl. No.: 18/164,284

(22) Filed: Feb. 3, 2023

Related U.S. Application Data
(60) Provisional application No. 63/344,343, filed on May 20, 2022.

(51) Int. Cl. H01Q 5/307; G06F 1/16; H01Q 1/22

(52) U.S. Cl. CPC H01Q 5/307; G06F 1/1698; H01Q 1/22

(57) ABSTRACT

The disclosed system may include a support structure that may be configured to house electronic components. The system may also include a first antenna mounted to the support structure. The first antenna may be configured to provide a wireless intralink on a first frequency to a local mobile electronic device. The system may also include multiple second antennas that are configured to established wireless interlinks on other frequencies to various external wireless networks. The second antennas may be positioned a specified minimum distance away from the first antenna and may be positioned at an at least partially opposing angle to each other. As such, the second antennas may provide at least a minimum threshold amount of spherical radiation to transmit and receive data using the established wireless interlinks. Various other apparatuses, methods of manufacturing, and mobile electronic devices are also disclosed.

### CROSS-REFERENCE TO RELATED APPLICATION

This application claims priority to and the benefit of U.S. Provisional Patent Application No. 63/344,343, filed May 20, 2022, which application is incorporated by reference herein in its entirety.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIGS. 1A-1G illustrate front perspective views of various example mobile electronic devices.

FIG. 2 illustrates a front perspective view of an example mobile electronic device.

FIGS. 3A-3G illustrate embodiments of a mobile electronic device establishing and implementing different communication links between the mobile electronic device and other electronic devices.

FIGS. 4A-4H illustrate embodiments of a mobile electronic device including placements of various electronic components.

FIGS. 5A and 5B illustrate frequency spectrums and indications of where different radios fall on the frequency spectrums.

FIGS. 6A-6G illustrate embodiments of a mobile electronic device without an outer covering, showing one or more internal components.

FIG. 7 illustrates an implementation of a mobile electronic device as potentially used by a user.

FIGS. 8A-8D illustrate alternative implementations of a mobile electronic device as used by a user.

FIGS. 9A-9C illustrate embodiments in which different antennas may be positioned in different places within a mobile electronic device.

FIGS. 10A-10C illustrate alternative implementations of a mobile electronic device as potentially used by a user.

FIG. 11 illustrates an alternative embodiment in which an ultrawideband antenna is implemented in the mobile electronic device.

FIG. 12 illustrates a flow diagram of an exemplary method of manufacturing a mobile electronic device.

FIG. 13 is an illustration of exemplary augmented-reality glasses that may be used in connection with embodiments of this disclosure.

FIG. 14 is an illustration of an exemplary virtual-reality headset that may be used in connection with embodiments of this disclosure.

FIG. 15 is an illustration of exemplary haptic devices that may be used in connection with embodiments of this disclosure.

FIG. 16 is an illustration of an exemplary virtual-reality environment according to embodiments of this disclosure.

FIG. 17 is an illustration of an exemplary augmented-reality environment according to embodiments of this disclosure.

FIGS. 18A and 18B are illustrations of an exemplary human-machine interface configured to be worn around a user's lower arm or wrist.

FIGS. 19A and 19B are illustrations of an exemplary schematic diagram with internal components of a wearable system.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

The present disclosure is generally directed to an antenna design for a mobile electronic device. In some cases, the mobile electronic device may be implemented as a computational hub or a communications hub for peripheral devices. The mobile electronic device may have multiple different types of antennas, as well as cameras, sensors, and other electronic components. In some other types of mobile devices, sufficient space exists to accommodate various antennas, sensors, and other components without the components interfering with the antennas. However, in at least some of the embodiments described herein, form factor constraints or other size constraints may limit the amount of space available to position antennas. Moreover, the large number of antennas implemented in the mobile electronic device described herein may impose transmission and reception constraints that are not experienced by other devices.

For example, each of the antenna classes that may be implemented in the mobile electronic device described herein including, for example (and not by way of limitation), 53-65 GHz antennas (e.g., line-of-sign or LOS antennas), FR2 antennas (e.g., 24-53 GHz), and FR1 antennas (e.g., 0.5-8 GHz)) may require a minimum level of spherical coverage. This minimum level of spherical coverage (i.e., the spherical radiation level), however, may also be required not to interfere with other antennas (or at least to keep interference below a specified maximum level). The antennas may also need to be placed so as to avoid occlusion by a user's fingers or a user's hand while in use.

For instance, the mobile electronic devices described herein may be used in multiple different scenarios such as augmented phone calls, in which the mobile electronic device may be laid on a platform with direct line of sight to another mobile device (e.g., a virtual reality head mounted device (HMD), a pair of artificial reality glasses, a smartwatch, an internet of things (IoT) device, etc.). The mobile electronic devices described herein may also be used in “augmented world” scenarios in which the mobile electronic device may act as a computer processing system and/or communications device for other local devices. In such cases, the mobile electronic device may be placed in a user's pocket or backpack or may be held in one of the user's hands as a gaming input device. In other scenarios, the mobile electronic devices described herein may be implemented in an ultra-low friction communication scenario in which the mobile electronic device may be used to facilitate real-time video and/or audio communication with other individuals or entities. In such cases, the mobile electronic device may be held in landscape position with two hands for messaging or point of view (POV) capture.

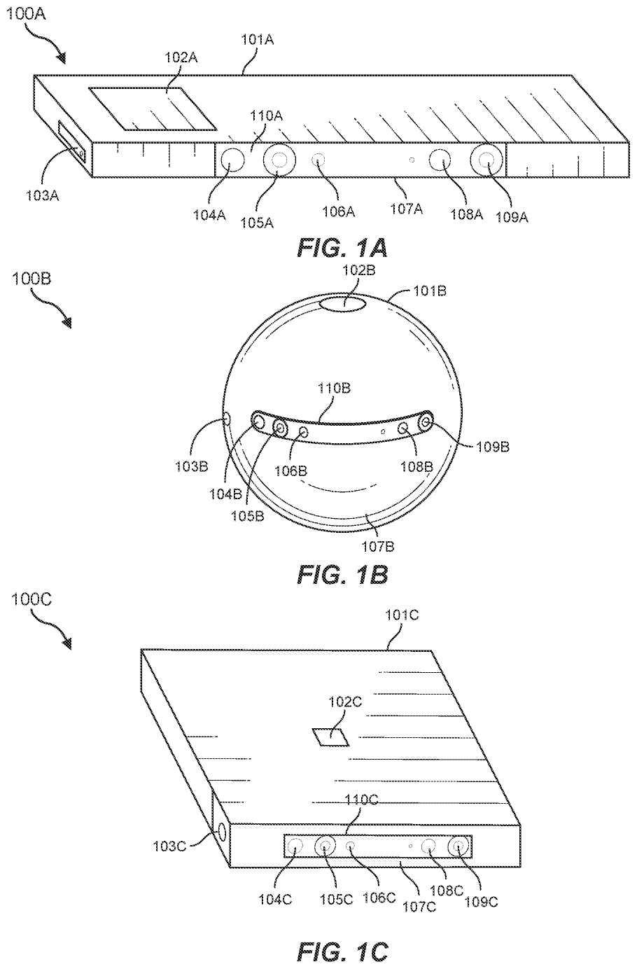

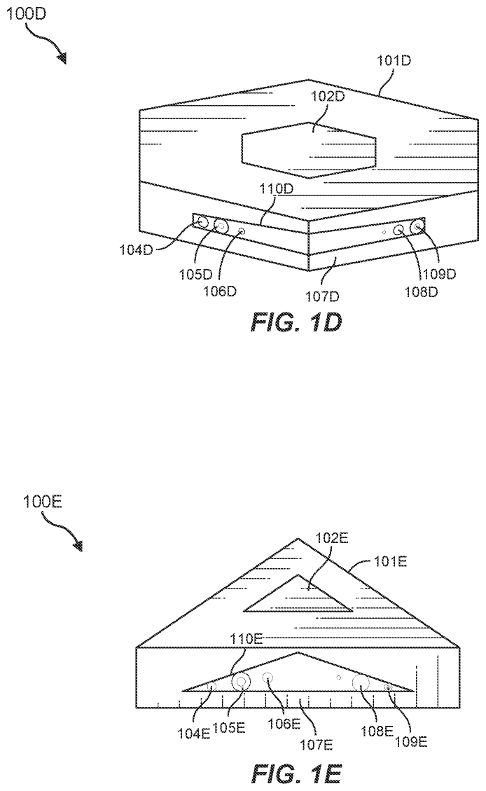

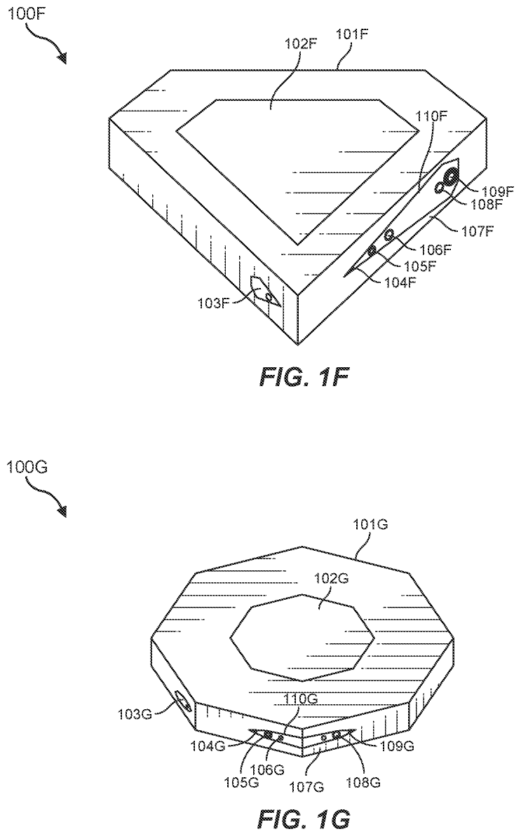

In each of these use case scenarios, or in different scenarios, different antennas may be used. In each scenario, the user's hands may be in different positions relative to the mobile electronic device. Thus, in light of space constraints, in light of power and interference constraints, and in light of different use scenarios in which the user's hands may be placed in different positions on the device leading to possible occlusions, the embodiments herein may provide an antenna design or antenna architecture that optimally places each of the antennas of the different types of antennas where they will be able to fit into an underlying support structure in relation to other components, where and how they will function in relation to interference caused by other components, and where they will operate substantially without occlusion or with only minimal occlusion in the various use case scenarios. These embodiments will be described in greater detail below. Other embodiments, including details regarding materials used in constructing or manufacturing the mobile electronic device, material thicknesses, and dimensions for the mobile device's support structure may also be provided. Still further, at least in some cases, these embodiments may include ultrawideband (UWB) antennas, as will be explained in greater detail below with regard to FIGS. 1A-19B.

Features from any of the embodiments described herein may be used in combination with one another in accordance with the general principles described herein. These and other embodiments, features, and advantages will be more fully understood upon reading the following detailed description in conjunction with the accompanying drawings and claims.

FIGS. 1A-1G illustrate an embodiment of a mobile electronic device (e.g., 100A-100G). The mobile electronic devices 100A-100G may be manufactured or produced using many different form factors, including form factors with sizes and shapes not shown in FIGS. 1A-1G. By way of example and not limitation, the mobile electronic devices 100A-100G of FIGS. 1A-1G may be created in a rectangular shape (e.g., 100A of FIG. 1A), in a spherical shape (e.g., 100B of FIG. 1B), in a square shape (e.g., 100C of FIG. 1C), in a hexagonal shape (e.g., 100D of FIG. 1D), in a triangular shape (e.g., 100E of FIG. 1E), in a diamond shape (e.g., 100F of FIG. 1F), or in an octagonal shape (e.g., 100G of FIG. 1G). The various buttons, sensors, antennas, or other components may also be shaped differently, sized differently, or placed in different locations. Thus, the placement or configuration of components including touchpads, buttons, cameras, inertial motion units (IMUS), altimeters, infrared sensors, lights, haptics units, antennas, or other components may vary between embodiments of the mobile electronic devices 100A-100G.

Moreover, it will be understood that different shapes or sizes of the mobile electronic devices 100A-100G may accommodate different components, and may allow different placements for antennas or other components. For instance, the rectangular-shaped mobile electronic device 100A of FIG. 1A may allow for antenna placements (within radiation and interference limits) that may not be permitted on spherical-shaped mobile devices or triangular-shaped mobile devices, or vice versa. Still further, different shapes or form factors may allow different sensor bars (e.g., 110A of FIG. 1A), different types of antennas, different types or shapes of touchpads (e.g., 102A), or different placements of sensors (e.g., simultaneous location and mapping (SLAM) sensor 103A). Thus, while the rectangular-shaped embodiment of FIG. 1A will be referred to frequently herein, any of the shapes or sizes of the mobile electronic devices 100A-100G may be used in different scenarios.

In some cases, the mobile electronic devices 100A-100G may be designed to operate in conjunction with other mobile or stationary electronic devices. These electronic devices may include smartphones, smartwatches, VR HMDs, artificial reality glasses, laptops, tablets, personal computers, IoT devices (e.g., smart doorbells, refrigerators, coffee makers), or other electronic devices that are capable of wired or wireless communication. The mobile electronic devices 100A-100G may include different types of antennas to communicate on intralinks (e.g., wireless communications between local devices) or on interlinks (e.g., wireless communications between remote devices including wireless connections to the internet). In some cases, the mobile electronic devices 100A-100G may include processors, controllers, or other processing means to perform at least some amount of processing for the local devices connected via intralinks.

Thus, for instance, the mobile electronic devices 100A-100G may provide processing capabilities for connected VR HMDs or artificial reality devices (e.g., augmented reality glasses) or smartwatches. In such cases, the HMDs, glasses, or smartwatches may turn over processing tasks to the mobile electronic devices 100A-100G where those tasks will be processed. Upon completion of those tasks, the mobile electronic devices 100A-100G may then return the processed results to the local devices. In this manner, the mobile electronic devices 100A-100G may communicate with local electronic devices, perform processing for those devices, and return the results of the processing to those devices. Moreover, the mobile electronic devices 100A-100G may connect to cellular, global navigational satellite system (GNSS), or other remote computer networks to retrieve information and pass that information to the local devices. In this manner, the mobile electronic devices 100A-100G may function as a processing and/or communications hub for these local electronic devices.

In some cases, the local electronic devices may include artificial reality devices. These artificial reality devices may, themselves, include many different types of electronic hardware. In some cases, for example, artificial reality devices may include head-mounted displays that provide a virtual reality environment or augmented reality glasses that provide an augmented reality environment. In such cases, these HMDs may fully cover the user's eyes, and the user may be entirely enveloped in the virtual environment. In other cases, artificial reality devices may include augmented reality glasses or other similar devices. In such cases, the augmented reality glasses may allow the user to still see the world around them, but may project virtual objects into the physical world. As such, the wearer of the augmented reality glasses may see real world objects as well as virtual objects that are projected onto the user's eyes by the augmented reality glasses. Smartphones, smartwatches, and other mobile electronic devices may be used in conjunction with these artificial reality devices and/or with the mobile electronic devices 100A-100G.

As noted above, the mobile electronic devices 100A-100G may include many types of antennas, sensors, and other electronic components. These antennas may include WiFi antennas, Bluetooth antennas, global navigation satellite system (GNSS) or global positioning system (GPS) antennas, cellular antennas (e.g., 5G, 6G, 7G, etc.), Ultrawideband (UWB) antennas), near-field communication (NFC) antennas, or other types of antennas. The mobile electronic devices 100A-100G may also include microphones, speakers, batteries, cameras, printed circuit boards (PCBs), touch sensors, buttons, insulating or heat conducting materials for thermal management, or other components. For example, the mobile electronic devices 100A-100G may include an outer housing 101A-101G. The housing 101A-101G may cover or provide protection for one or more interior components including processors, memory, antennas, or other electronic components embedded on a PCB. In some places, the housing 101A-101G may include cutouts that allow placement of sensors or similar components on the ends or edges of the device.

For example, the housing 101A-101G may include a rectangular cutout that allows placement of a sensor structure 110A-110G. The sensor structure may be shaped differently in different applications. For instance, the sensor structure 110A may be rectangular in FIG. 1A, sensor structure 110B may be spherical in FIG. 1B, sensor structure 110C may be square shaped in FIG. 1C, sensor structure 110D may be hexagonal in FIG. 1D, sensor structure 110E may be triangular in FIG. 1E, sensor structure 110F may be diamond-shaped in FIG. 1F, and sensor structure 100G may be octagonal in FIG. 1G. Regardless of its shape, the sensor structure 110A-110G may house one or more sensors or other components (e.g., 104A-104G to 109A-109G). Although the sensor structures 110A-110G are shown as having six components, it will be understood that the sensor structures 110A-110G of FIGS. 1A-1G may include substantially any number of sensors or other components. In these example figures, the sensor structures 110A-110G may include a depth sensing infrared (IR) sensor 104A-104G, a right-side camera 105A-105G, an ambient light sensor 106A-106G, a power indicator light and/or a privacy indicator light 107A-107G, a depth IR projector 108A-108G, and a left-side camera 109A-109G. In some embodiments, the mobile electronic devices 100A-100G may include a bezel or touchpad 102A-102G that receives touch inputs from a user. Other components may also be implemented in the mobile electronic devices 100A-100G, as will be described further below.

In some cases, the mobile electronic device housings 101A-101G may include cutouts for SLAM sensors 103A-103G, buttons (e.g., power, volume, etc.), communication ports (e.g., USB ports), power ports (e.g., for wired charging), or other cutouts. The mobile electronic device housings 101A-101G may be provided in a specified thickness that allows for structural stability while still allowing for cutouts for sensors, antennas, or other components. In some cases, certain types of antennas (e.g., FR2 antennas) may have improved antenna reception or transmission with a thicker housing. Other types of antennas (e.g., LOS, 60 GHz) may transmit or receive more efficiently with a thinner housing. The embodiments herein may use various levels of thickness and, in some cases, may implement a thickness that is thinner than preferred for FR2 antennas, but thicker than preferred for LOS antennas. This intermediate thickness value may additionally allow for sensor or component cutouts while still maintaining structural integrity.

The mobile electronic device housings 101A-101G may be formed using plastic, glass, metal, ceramic, or a combination of such materials. In some cases, the antennas (e.g., the LOS antennas) may be designed to operate at a lower frequency than designed when placed behind glass, as the glass may detune the electromagnetic waves that travel through the glass. In some cases, specific distances may be established between glass portions and antennas, or between plastic portions and antennas. In some cases, grounded components including, for example, communication ports, may be placed between antennas to reduce correlation between those antennas. The housing may thus accommodate antennas, sensors, communication ports, or other mechanical or electrical components.

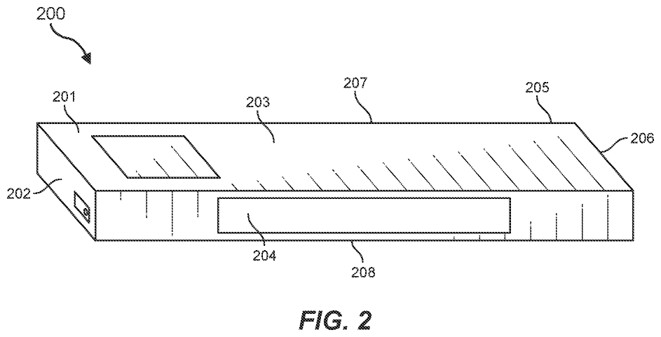

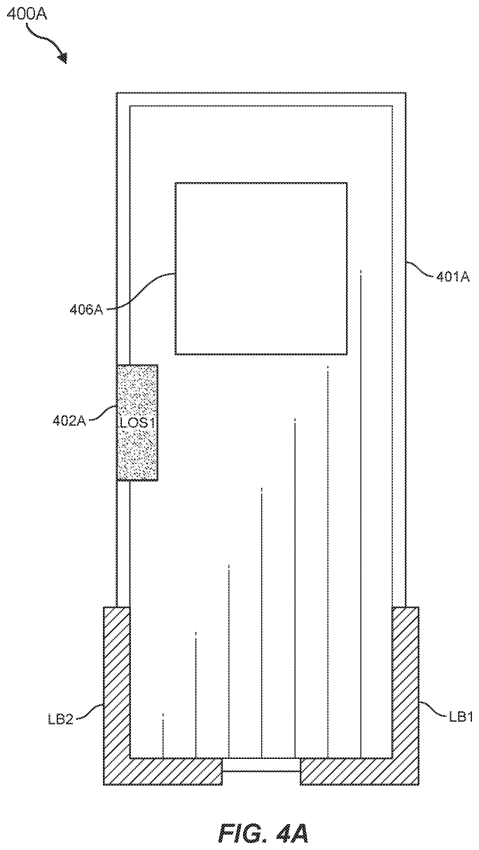

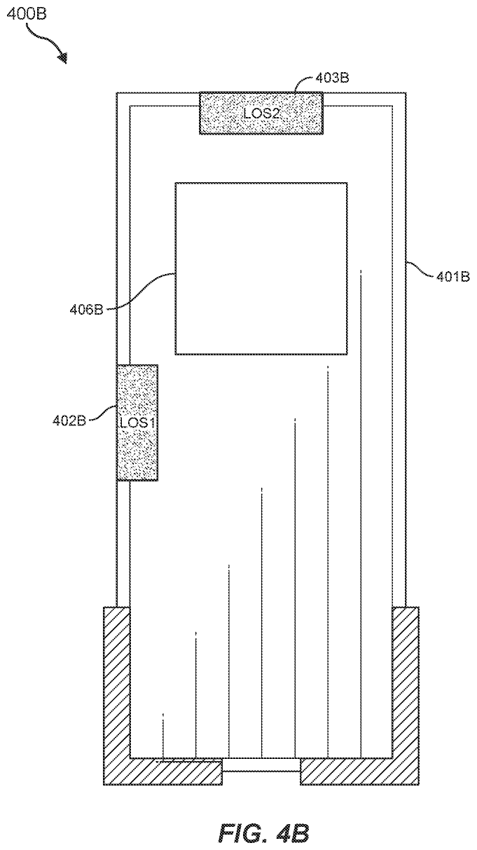

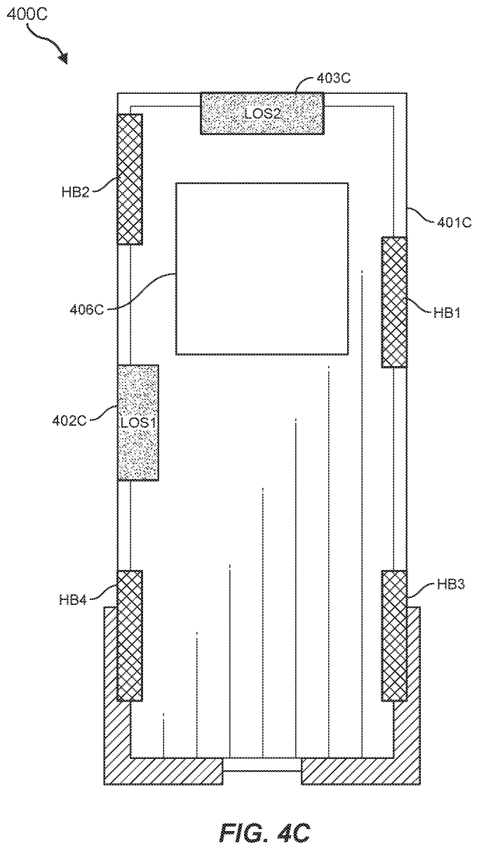

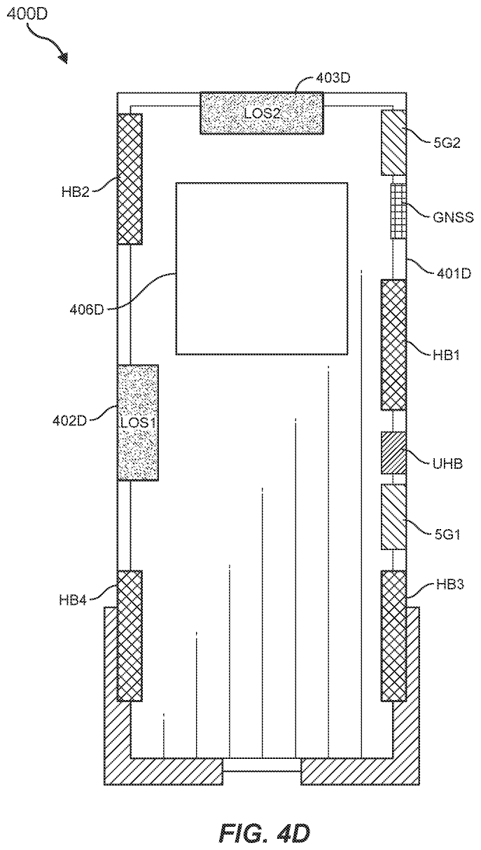

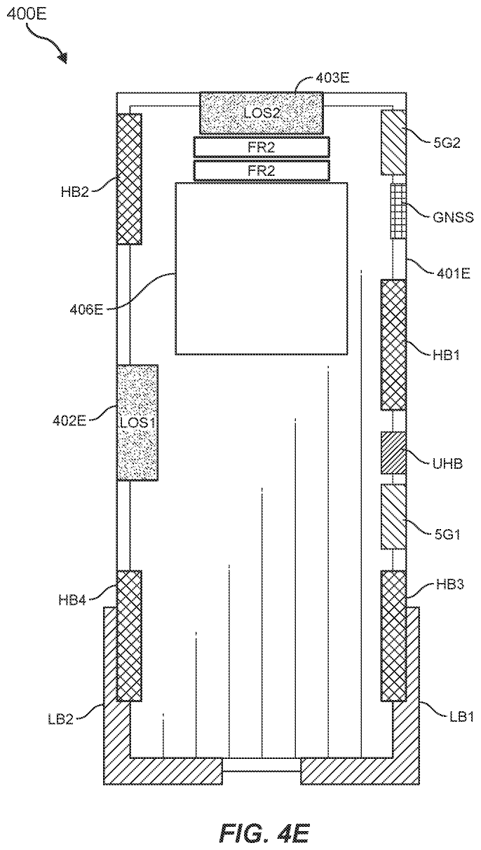

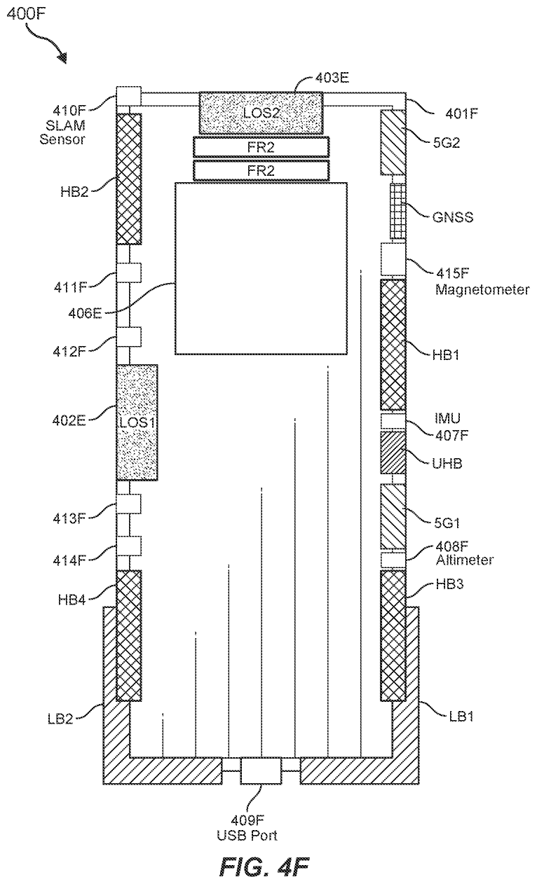

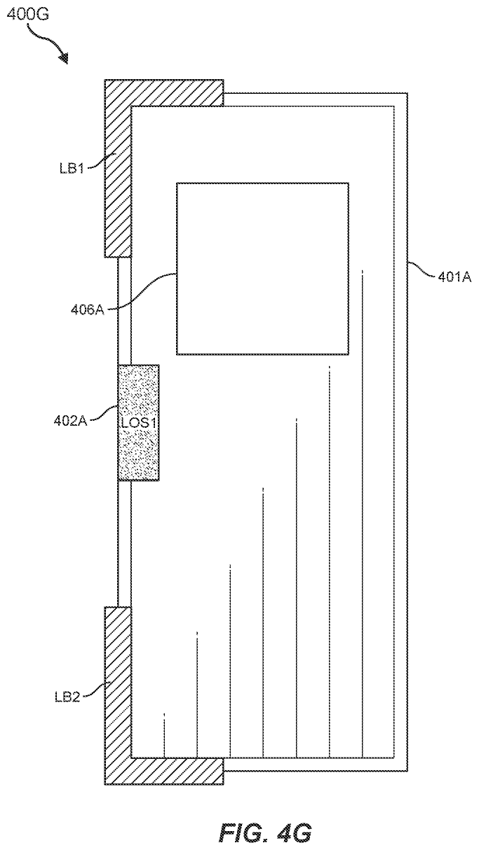

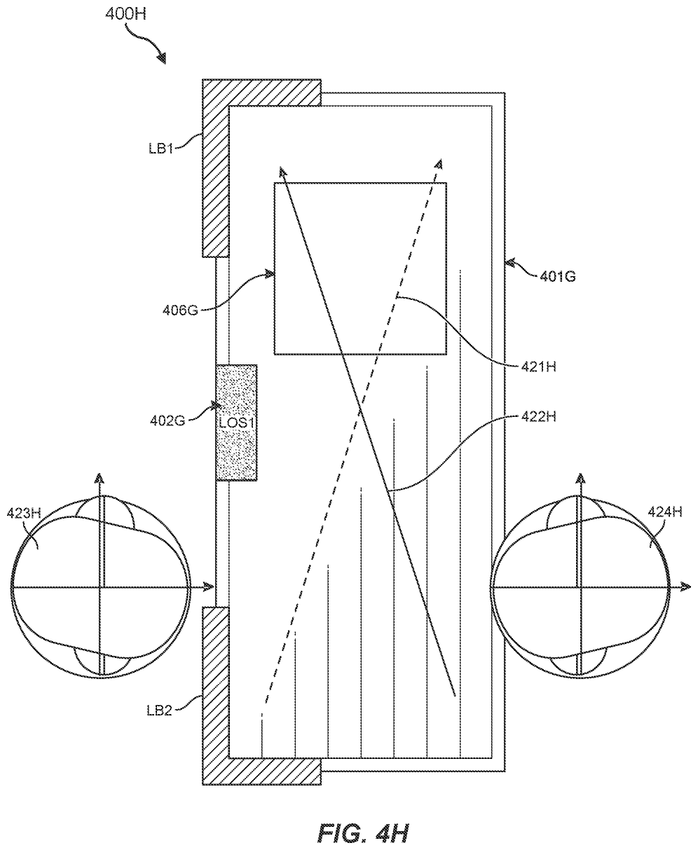

The mobile electronic device 200 of FIG. 2 may be similar to or the same as mobile electronic device 100A of FIG. 1A. The mobile electronic device 200 may be positioned horizontally in a landscape mode, or may be positioned vertically in a portrait mode (e.g., as shown in FIGS. 4A-4G). Throughout this disclosure, and for simplicity's sake, the various portions of the mobile electronic device 200 will be described in similar terms throughout, regardless of which position the mobile electronic device 200 is in. Thus, the mobile electronic device 200 will have a front-facing portion 207 and a rear-facing portion 208. The front-facing portion 207 may include the top half of the mobile electronic device 200 if the device were to be divided in half horizontally along the x-axis in landscape mode, and the rear-facing portion 208 may include the bottom half of the device if divided along the x-axis in landscape mode. The mobile electronic device 200 may also include a left side 202 and a right side 206 when viewed horizontally. These sides may also be referred to as the top side 201 or bottom side 205 when viewed in portrait mode. The left side 202 may refer to the left half of the device if the device were divided vertically along the y-axis, and the right side 206 may refer to the right half of the device if the device were divided vertically. The horizontal face 204 may be facing a user or facing a local device when in landscape mode, while the vertical front face 203 may be facing a user or facing a local device when in portrait mode. Accordingly, these terms will be used when referencing different parts of the mobile electronic device 200 herein.

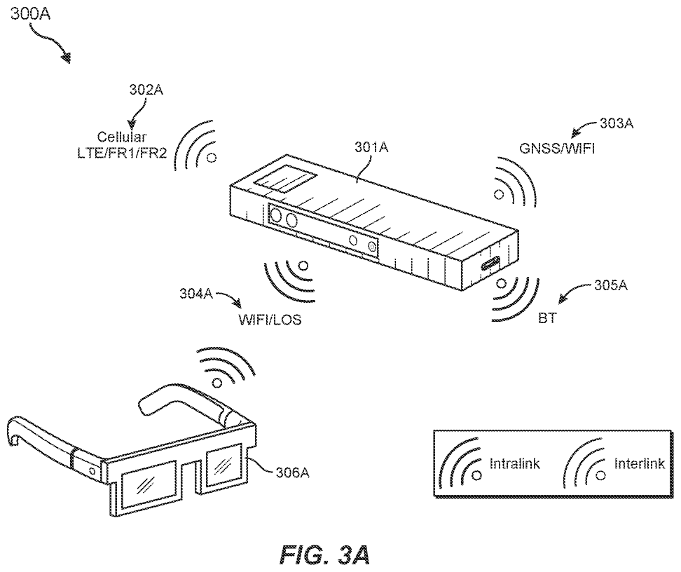

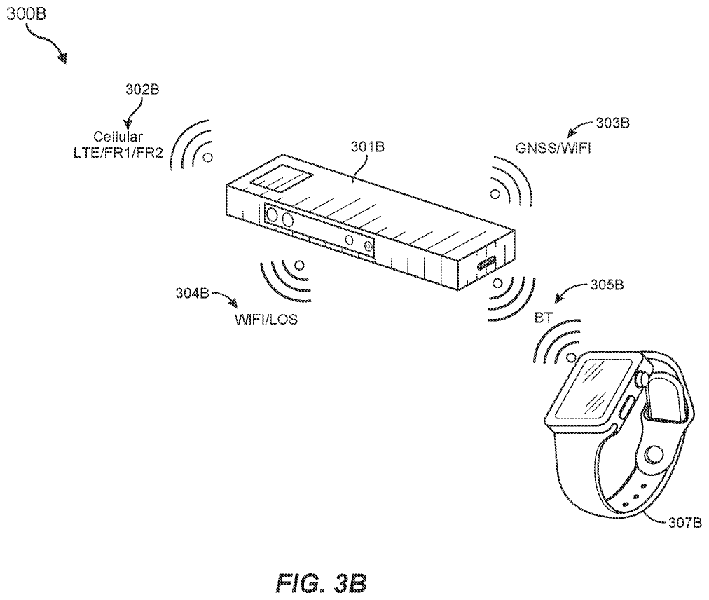

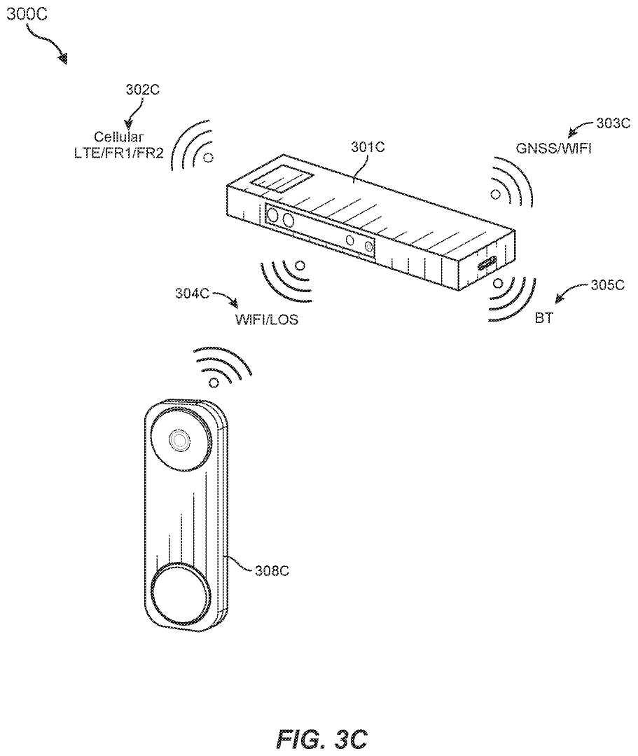

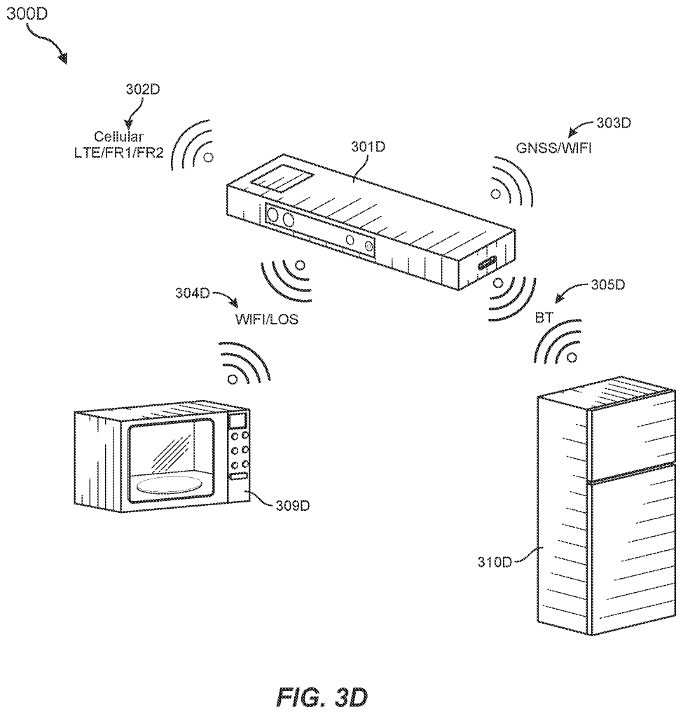

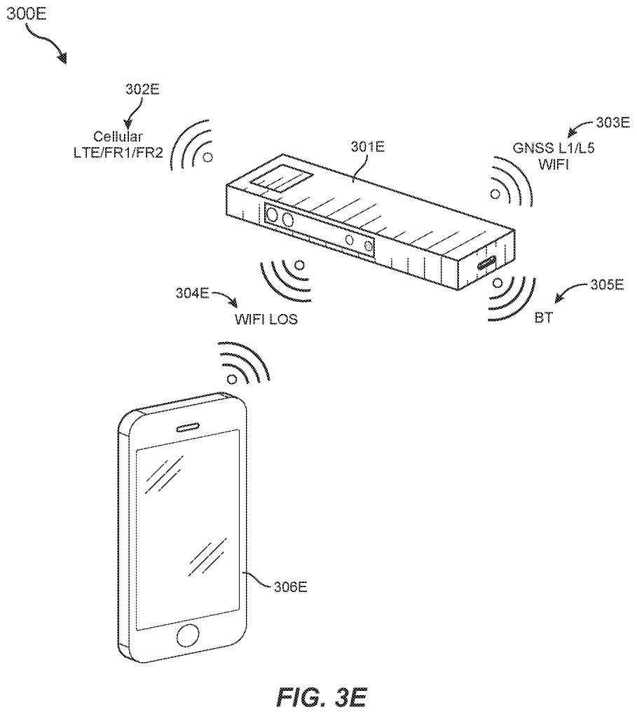

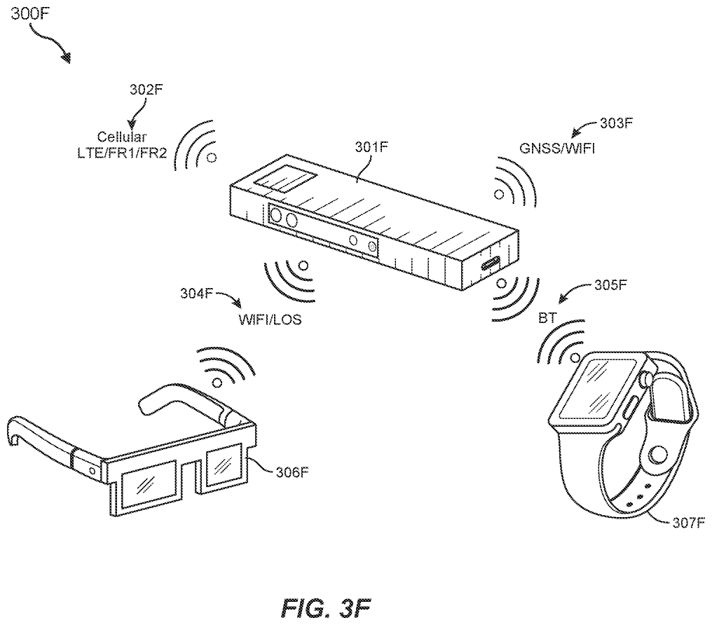

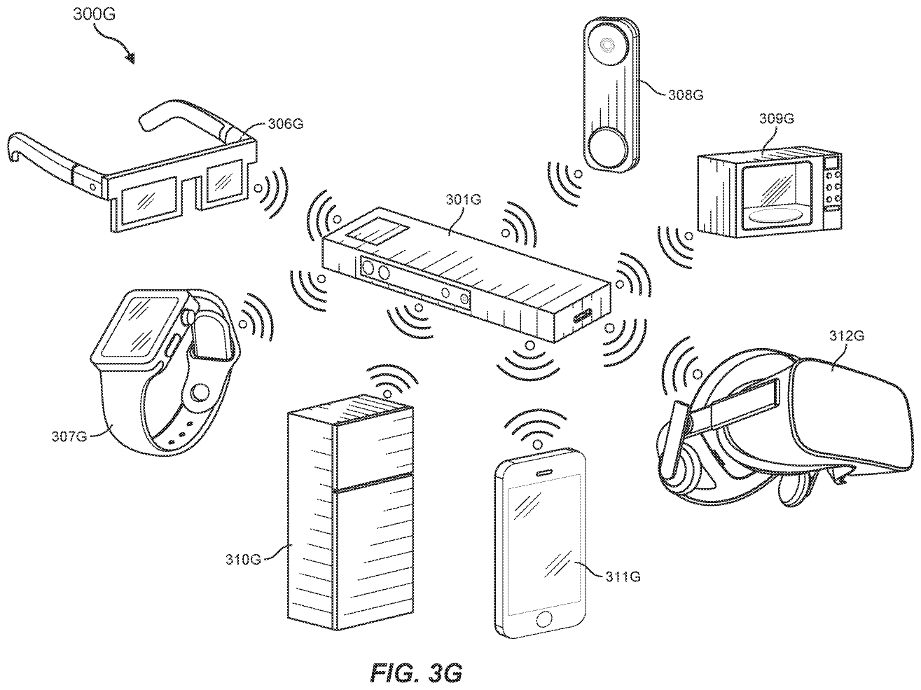

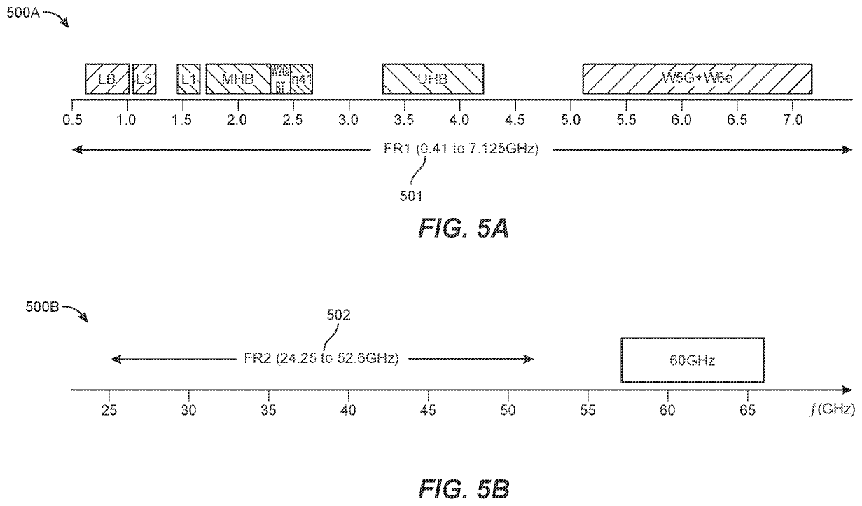

FIGS. 3A-3G illustrate embodiments 300A-300G of a mobile electronic device 301A-301G that may be in communication with other local or remote electronic devices. As shown in FIGS. 3A-3G, the mobile electronic device 301A-301G may communicate with many different types of devices on many different types of antennas or radios. These radios may establish intralinks and interlinks. As the terms are used herein, “intralinks” may refer to wireless communication links between local devices that are within a few hundred feet of the mobile electronic device 301A-301G. The term “interlinks” may refer to wireless communication links between remote devices that may be any distance from the mobile electronic device 301A-301G, including anywhere in the world or space (e.g., links to satellites). Interlinks may be established using cellular radios 302A-302G (e.g., long term evolution (LTE), 5G, 6G, 7G, etc.), FR1 frequency radios (e.g., 617 MHz-7.125 GHz, see 501 of FIG. 5A), FR2 frequency radios (e.g., 24.25-52.66 GHz, see 502 of FIG. 5B), GNSS radios 303A-303G, WiFi radios or other similar communications devices. Intralinks may be established using WiFi or line of sight (LOS) radios (e.g., 60 GHz radios) 304A-304G, Bluetooth radios 305A-305G (e.g., to a pair of artificial reality glasses 306A-306G or to a smartwatch 307B-307G, etc.), near-field communication (NFC) radios, or other antennas designed to operate over relatively short distances (e.g., within 1-300 feet).

In FIG. 3A, a mobile electronic device 300A may be configured to establish an intralink between itself and a pair of artificial reality glasses 306A. The intralink may be established over a WiFi radio, over a Bluetooth radio, over an NFC radio, or over a LOS connection. In the case of the line-of-sight intralink connection 304A, the antenna may be designed to operate at ultra-high frequencies, including 60 GHz or in the range of 53-60+GHz. Such antennas may experience a high degree of directionality and, as such, may operate most efficiently when the LOS antennas have a direct line of sight to the local electronic device. Thus, in FIG. 3A, the mobile electronic device 300A may establish a direct, line-of-sight intralink connection 304A between itself and the artificial reality glasses 306A. This line-of-sight intralink connection 304A may provide a relatively large amount of bandwidth for communication between the devices 301A and 306A. This bandwidth may be used, for example, to provide augmented calling to the user wearing the artificial reality glasses 306A.

In augmented calling, the artificial reality glasses 306A may project a moving, lifelike image of another caller (or group of callers) as being in the same room as the wearer of the glasses 306A, even if those callers are located far away from the wearer. In such cases, the mobile electronic device 300A may establish an interlink to other callers' devices and an intralink to the artificial reality glasses 306A. Then, the mobile electronic device 300A may facilitate an augmented call between the wearer of the glasses and one or more remote callers, projecting moving images of those callers onto the glasses wearer's current environment. In such a scenario, multiple different types of antennas may be simultaneously operating within the mobile electronic device 300A to allow augmented calling.

FIG. 3B illustrates an embodiment 300B in which a mobile electronic device 301B may establish an intralink connection to a smartwatch 307B. The smartwatch 307B may be any kind of smartwatch that is capable of wireless communication. In some cases, the mobile electronic device 301B may establish an intralink between itself and the smartwatch 307B using a Bluetooth connection, an NFC connection, or other type of local wireless connection. In some cases, the smartwatch 307B may run applications that use data provided through the mobile electronic device 301B. In some embodiments, the mobile electronic device 301B may provide processing resources for the smartwatch 307B, or may provide navigational instructions, or may connect cellular phone calls, or perform other functions in conjunction with the smartwatch 307B.

FIG. 3C illustrates an embodiment 300C in which the mobile electronic device 301C is implemented to establish an intralink connection to a smart doorbell 308C, or to other internet of things (IoT) devices such as a microwave oven 309D or refrigerator 310D (as shown in embodiment 300D of FIG. 3D) or to other IoT devices. The mobile electronic device 301C/301D may be configured to establish intralink connections to substantially any number of different IoT or other local devices that are capable of wireless communication. The mobile electronic device 301C/301D may send commands to these IoT devices including viewing a camera feed from the smart doorbell 308C, turning the oven or microwave 309D to a specific temperature, changing the humidity level of the refrigerator 310D, or performing other tasks. The mobile electronic device 301C/301D may receive and/or store information from these IoT devices and, in some case, may pass this data on to remote data stores via an interlink.

In embodiment 300E of FIG. 3E, the mobile electronic device 301E may establish an intralink and/or an interlink with a smartphone 311E. The mobile electronic device 301E may, at least in some cases, provide processing resources including CPU cycles, RAM, and/or data storage for the smartphone 311E. Additionally or alternatively, the mobile electronic device 301E may provide communication capabilities for the smartphone. For instance, if the smartphone 311E is incapable of making a cellular connection, the smartphone may connect locally using an intralink to the mobile electronic device 301E, and may use the mobile electronic device's interlink connections to communicate with remote devices.

In some examples, as shown in embodiments 300F of FIGS. 3F and 300G of FIG. 3G, the mobile electronic device 301F/301G may establish intra links with multiple different types of electronic devices including artificial reality glasses 306F/306F, smartwatches 307F/307G, smart doorbells 308G, IoT devices such as oven 309G, refrigerator 310G, smartphone 311G, virtual reality headsets 312G, or other devices. Each of these wireless connections may be established using different types of radios including WiFi, Bluetooth, NFC, LOS, or other radios. Accordingly, at least in some embodiments, the mobile electronic device 301F/301G may be simultaneously communicating with multiple different local and/or remote devices using multiple different types of radios. As such, the mobile electronic device 301F/301G may be designed to allow some or all of these radios to operate simultaneously to allow for synchronous communication with many different local and remote devices. At least some of these designs are illustrated in FIGS. 4A-10C.

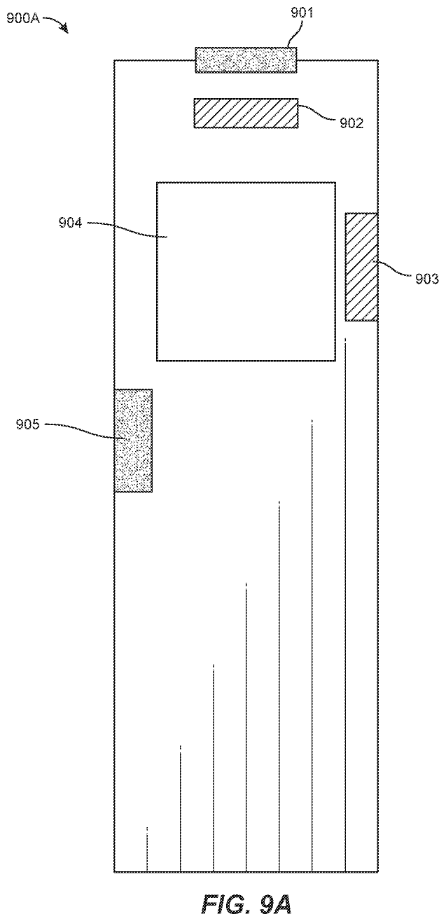

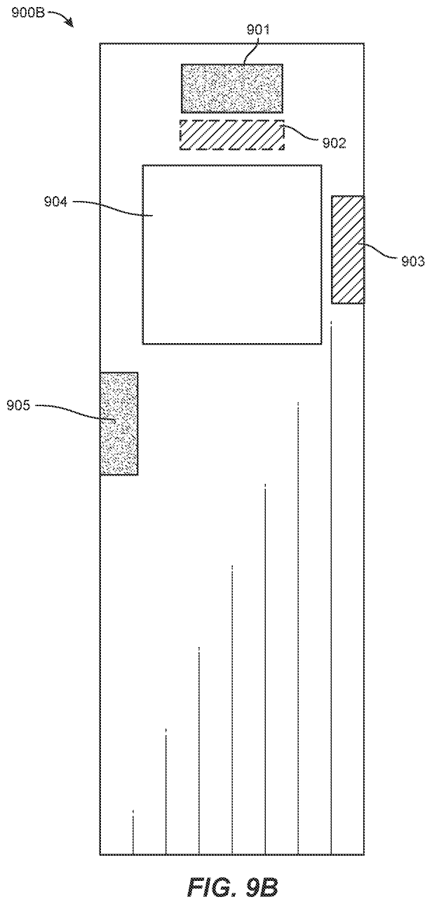

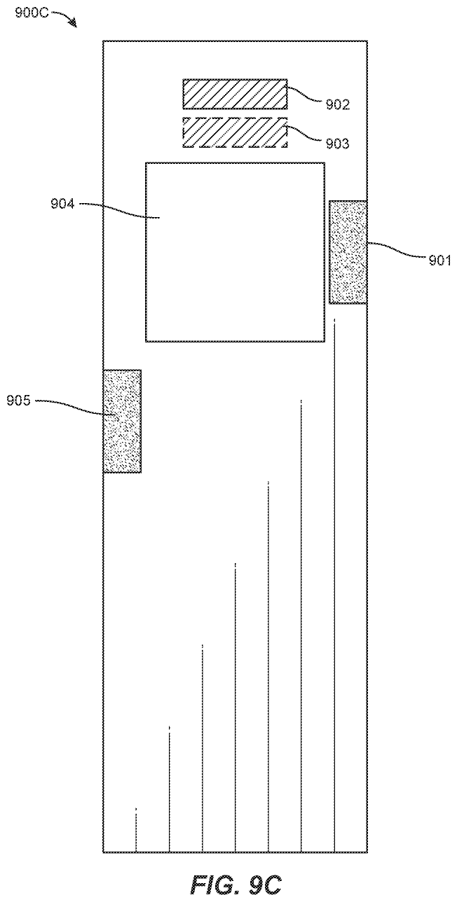

FIG. 4A, for example, includes multiple different antennas including a first low band (LB) antenna LB1 and a second low band antenna LB2. The two low band antennas may be placed on the same end of the mobile electronic device 400A, or may be placed on different ends of the device. In the illustrated embodiment, the low band antennas LB1 and LB2 are positioned on opposite sides of the bottom end of the mobile electronic device 400A. As will be explained further below with regard to FIGS. 9A-9C, by positioning the low band antennas on opposite sides and at a minimum offset angle with respect to each other, each of these antennas may maintain sufficient isolation for efficient operation. As noted in chart 500A of FIG. 5A, the term “low band” may refer to frequencies in the range of 0.6-1.0 GHz. These low band antennas may include cellular antennas designed to create interlinks to external, remote communications networks within the frequency range of approximately 0.6-1.0 GHz. In some cases, two low band antennas may be implemented, while in other cases, more or fewer low band antennas may be used. Each of these antennas may be internally or externally mounted to the body or support structure 401.

Additionally or alternatively, the mobile electronic device 400A may include at least one line-of-sight (LOS) antenna 402A. The LOS1 antenna may be placed on the front face of the support structure 401A of the mobile electronic device 400A when viewed in landscape mode and may be placed on the left side of the mobile electronic device 400A when viewed in portrait mode. The LOS1 antenna may be enclosed plastic or other RF transparent material that will not attenuate or distort its radiation pattern. The LOS1 antenna may operate, as noted in chart 500B of FIG. 5B, at or close to 60 GHz (e.g., within 100 MHz). When placed horizontally on a flat surface, such as when conducting augmented calls, for example, the LOS1 antenna may communicate directly with a VR headset or with a pair of artificial reality glasses. In some cases, the button or touchpad 406A may be implemented to interact with applications run by the mobile electronic device 400A including augmented calling applications.

Still further, at least in some cases and as shown in FIG. 4B, the mobile electronic device 400B may include a secondary or alternative LOS antenna (e.g., LOS2 (403B)). LOS2 may also operate at or near 60 GHz. When used vertically, such as when playing games and holding the mobile electronic device 400B as a controller, the LOS2 antenna may communicate directly with a gaming system, with a smartphone, or with another local device using a line-of-sight 60 GHz connection. The LB1 and LB2 antennas may be placed away from the LOS1 and LOS2 antennas so as to provide sufficient isolation for each antenna. Moreover, this additional space between the LOS1 and LOS2 antennas and the LB1/LB2 antennas may allow space for thermally protective material, space for sensors, space for cameras, or other components. In some embodiments, for example, the LOS1 antenna (402B) may have cameras and/or other sensors positioned on either side of it. In FIG. 4B, the touchpad 406B is illustrated as being positioned between the LOS1 and LOS2 antennas. However, in some cases, the touchpad 406B may be moved to alternate positions, including on the bottom end of the support structure 401B.

FIG. 4C illustrates an embodiment of a mobile electronic device 400C that has multiple antennas positioned to allow isolation between each different type of antenna. For instance, the mobile electronic device 400C may include line-of-sight antennas LOS1 (402C) and LOS2 (403C). Additionally or alternatively, the mobile electronic device 400C may include high band antennas HB1, HB2, HB3, and/or HB4. As illustrated below in chart 500A of FIG. 5A, and as used herein, “high band” antennas may refer to antennas that operate in the medium-high band (MHB) and ultra-high band (UHB) ranges of 1.75 GHz to 2.75 GHz and 3.3 GHz to 4.2 GHz, respectively. Such high band antennas may include cellular antennas, Bluetooth antennas, WiFi antennas, or other types of antennas designed to operate in the high band frequency range. These high band antennas HB1-HB4 may be positioned on four opposite parts of the device's support structure 401C. While four high band antennas are used herein, it will be understood that more or fewer high band antennas may be used.

In FIG. 4C, the HB2 antenna is placed in the upper left corner between the LOS1 and LOS2 antennas and to the left of the touchpad 406C. In some cases, the touchpad 406C or other components may provide separation between the high band antennas, leading to greater isolation and more efficient operation. The high band antenna HB1 may be on the upper right side of the mobile electronic device 400C and may be separated from HB2, HB3, and/or HB4 by at least a specified minimum distance. This minimum distance may allow each high band antenna to generate spherical or directional radiation coverage to transmit and receive data. In this embodiment, the HB3 and HB4 antennas may be placed close to or immediately next to the LB1 and LB2 antennas. Because the HB3/HB4 and LB1/LB2 antennas operate on different frequencies, the amount of interference relative to each other (e.g., high band to low band interference) may be low enough to allow each antenna to provide a minimum output level of power. Thus, in this manner, the antennas of FIG. 4C may be positioned to allow each to operate in isolation of the other antennas, and may allow all antennas to operate simultaneously when needed.

FIG. 4D illustrates an embodiment of a mobile electronic device 400D in which a plurality of different antennas may be provided on a housing or support structure 401D. For instance, the support structure may include a first line-of-sight antenna LOS1 (402D) and/or a second line-of-sight antenna LOS2 (403D). A high band antenna HB2 may lie between the two LOS1/LOS2 antennas. Other high band antennas HB1, HB2, and/or HB4 may be placed in positions that are at least a minimum distance apart from each other to prevent interferences. Moreover, the high band antennas may be placed a minimum distance from the LOS1 and/or LOS2 antennas. The low band antennas LB1 and LB2 may be placed close to or immediately next to the HB3 and HB4 antennas. In some cases, additional antennas may be placed between the high band antennas. For instance, a first 5 GHz antenna (5G1) may be placed between HB1 and HB3, along with potentially other antennas including an ultra-high band antenna (UHB). A second 5 GHz antenna (5G2) (or other cellular antenna) may be positioned between HB2 and HB1, as shown in FIG. 4D, along with potentially other antennas including a global navigation satellite system (GNSS) radio. Between each of these antennas may lie a touchpad 406D.

Each antenna may have minimum operational specifications indicating a minimum amount of power needed to operate. Additionally, or alternatively, some or all of the antennas may specify a minimum amount of 3D spherical radiation coverage needed to operate properly or may specify a maximum amount of radiation coverage that can be provided by that antenna. Still further, some or all of the antennas may have specifications regarding heat dissipation or minimum distances between components for heat regulation. The embodiments herein, including the antennas shown in FIG. 4D for example, may be positioned in a manner that provides enough space between antennas to allow each antenna to operate at least at a minimum power level, provides at least a minimum specified 3D spherical radiation coverage, and/or provides a minimum amount of space for heat dissipation. In some cases, the antennas may be positioned in a manner that allows the antennas to operate at a level higher than the established minimum level or provide 3D spherical radiation coverage that is higher than the minimum level in the antenna's specifications. In such cases, extra distance may be placed between specific antennas so as to avoid interference caused by other signal transmissions when operated at the higher power levels.

FIG. 4E illustrates an embodiment of a mobile electronic device 400E that may be the same as or similar to that of FIG. 4D. In this case, however, in addition to the LOS1 (402E), LOS2 (403E), HB1-4, LB1-2, and other antennas (e.g., 5G1-2, GNSS, UHB), one, two, or more FR2 antennas (see 502 of FIG. 5B) may be placed on the support structure 401E of mobile electronic device 400E. In some cases, one of the FR2 antennas may be placed on a topside portion of the mobile electronic device 400E when viewed in landscape mode, while another FR2 antenna may be placed on a bottomside portion of the mobile electronic device 400E when viewed in landscape mode. One or both of the antennas may be placed on the top portion of the mobile electronic device 400E when viewed in portrait mode. Or, in other cases, one or both of the antennas may be placed in the bottom portion of the mobile electronic device 400E when viewed in portrait mode. In this topside and/or bottomside position, the FR2 antennas may avoid interfering with other antennas, while providing additional antenna coverage for the mobile electronic device 400E. Additional placements of FR2 antennas are illustrated in FIGS. 9A-9C and are described further below.

FIG. 4F may include some or all of the same antennas outlined in FIG. 4E. Additionally, the mobile electronic device 400F of FIG. 4F may include other components including cameras 411F and 414F, a depth sensor 412F, a privacy indicator 413F that surround LOS1 (402F). Still further, the mobile electronic device 400F may include a universal serial bus (USB) port 409 (or some other type of communications port) between LB1 and LB2. In some cases, this USB port 409F may be grounded, which may provide increased isolation for each of the low band antennas. Additionally or alternatively, the mobile electronic device 400F may include a magnetometer 415F, an IMU 407F, and/or an altimeter 408F. Each of these sensors or components may be placed far enough from other antennas to avoid absorbing the antennas' energy and to avoid reducing the antennas' volume. This separation between components may allow each antenna to operate substantially without interference from other antennas or other electronic components. Moreover, this separation allows each antenna to generate radiation coverage according to its specifications, even when working simultaneously with the other antennas and components.

FIG. 4G illustrates an embodiment of a mobile electronic device 400G that may be similar to or the same as 400A of FIG. 4A. The mobile electronic device 400G may include a body or support structure 401G, as well as a touchpad 406G and a first line-of-sight antenna LOS1 (402G). The mobile electronic device 400G may include at least two low band antennas LB1 and LB2. In this case, the LB2 antenna remains in the bottom left corner when viewing the device in portrait mode, but the LB1 antenna is placed in the top left corner in portrait mode. In this embodiment, the LB1 and LB2 antennas may provide orthogonal currents that reduce correlation between the antennas' signals.

However, at least in some cases, sensors (e.g., SLAM) sensors may prevent placement of the LB1 antenna in the top left corner of the mobile electronic device 400G. Accordingly, as shown in FIG. 4H, mobile electronic device 400H may place LB1 on the bottom right corner when viewing the device in portrait mode. In some cases, the low band antennas LB1 and LB2 may be at least partially angled so as to be offset from each other. Diagrams 423H and 424H illustrate the angled radiation patterns of the LB2 and LB1 antennas, respectively. In general, a low amount of correlation between the two antennas' signals is desirable. The correlation coefficient between the two antennas' signals may be proportional to the angular separation between the dominant current flow direction of the two antennas (421H and 422H). Accordingly, because the LB1 and LB2 antennas are at least partially angled away from each other, the correlation between the two antennas' signals may be low, resulting in a greater amount of the signal being transmitted or received by each antenna. This may, in turn, allow the LB1 and LB2 antennas to operate on less power or implement more power to transmit or receive in remote areas.

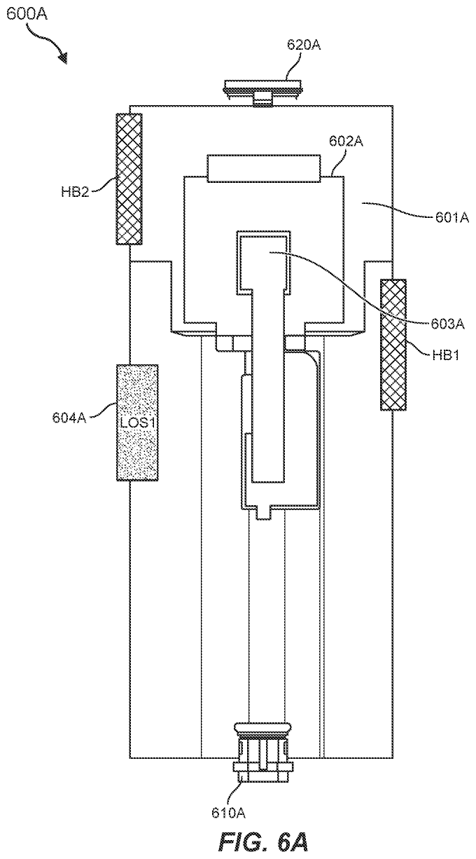

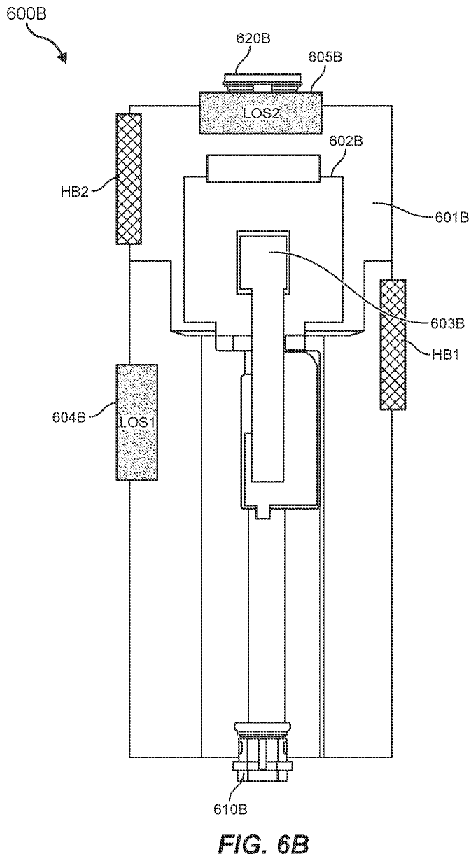

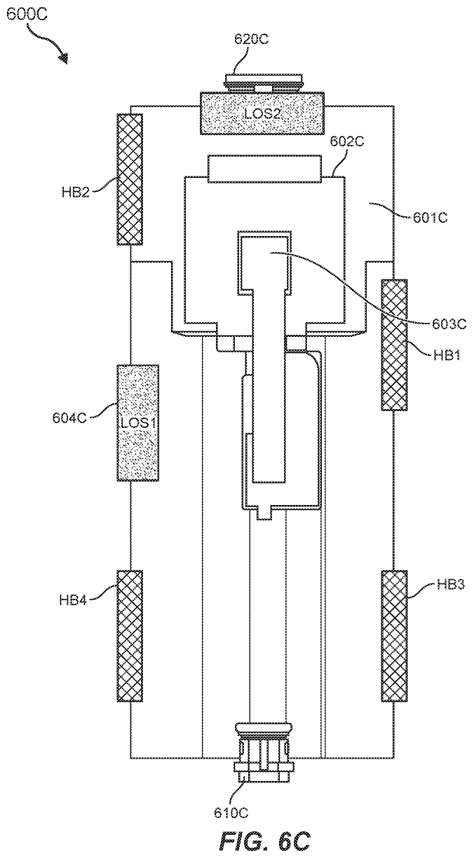

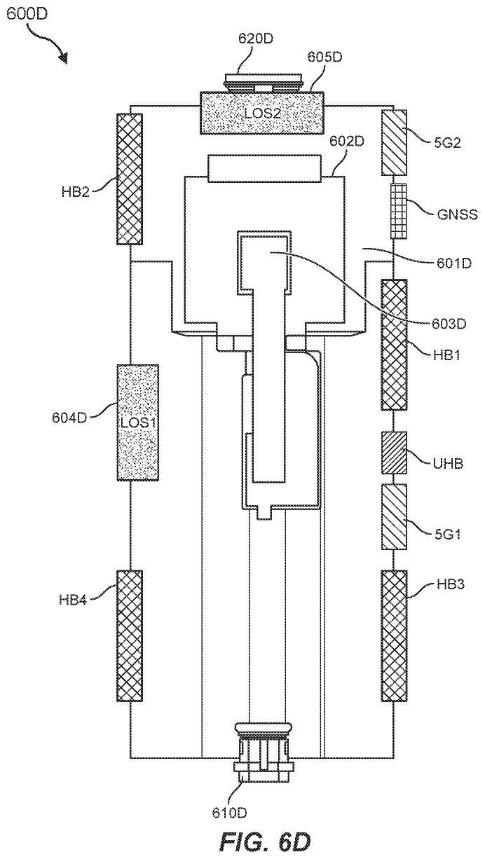

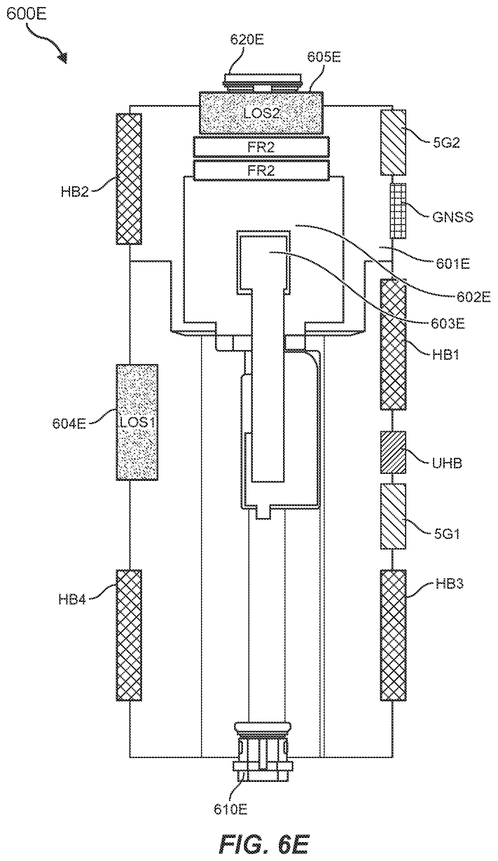

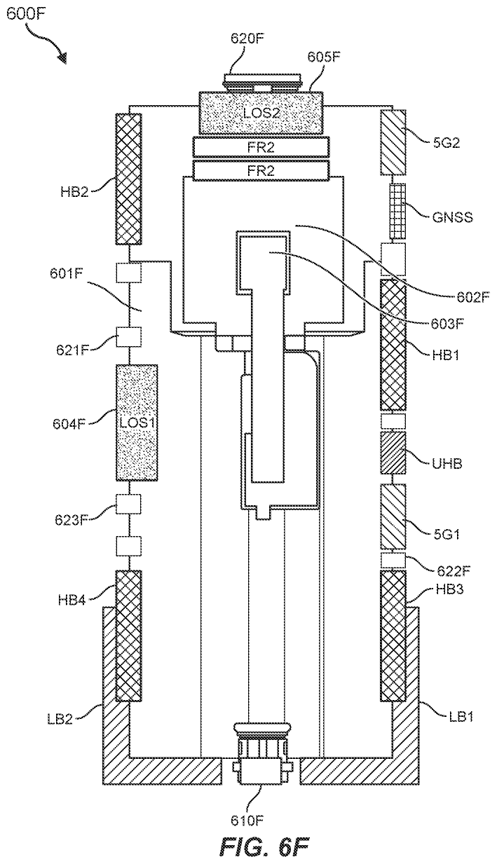

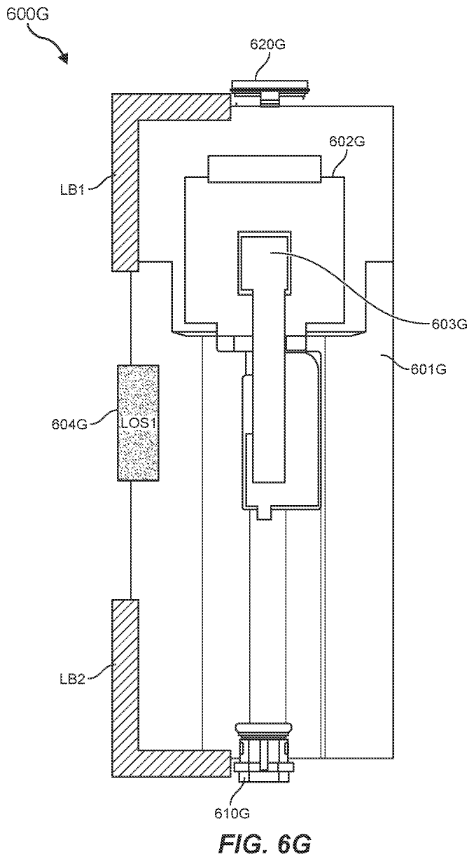

FIGS. 6A-6G illustrate embodiments of mobile electronic devices 600A-600G. These mobile electronic devices 600A-600G illustrate a component view that lacks an outer casing or outer body. The underlying support structure 601A-601G may include mounting points to hold various antennas and other components. For instance, the mobile electronic device 600A of FIG. 6A may include a line-of-sight antenna LOS1 (602A). As in FIG. 4A, the LOS1 antenna 604A-604G may operate in the 60 GHz range, and may establish line-of-sight communication with local mobile devices. In mobile electronic device 600A, the LOS1 antenna may be accompanied by two other antennas HB1 (high band 1) and HB2 (high band 2). These antennas may be positioned away from the LOS1 antenna, which may provide sufficient isolation for each of the three antennas to operate simultaneously. The mobile electronic device 600A may also include a button or touchpad 602A-602G and a trace 603A-603G that transmits user inputs on the touchpad to a processor or controller. In some cases, the mobile electronic device 600A may also include a button or sensor 620A-620G disposed on the top portion of the device when viewed in portrait mode, and a communications port 610A-610G such as a USB port on the bottom portion.

FIG. 6B illustrates an embodiment of a mobile electronic device 600B. The mobile electronic device 600B may be similar to or the same as device 600A, but may also include a second line-of-sight sensor LOS2 (605B-605G). This second LOS2 sensor may also be configured to operate in the 60 GHz range, and may establish line-of-sight connections to nearby electronic devices including any of those described in relation to FIG. 3G. The mobile electronic device 600C of FIG. 6C may include the components of FIG. 6B, but may also include additional high band antennas HB3 and HB4. These additional high band antennas HB3 and HB4 may be placed opposite of each other, and may be placed away from HB1 and HB2. In some cases, the HB3 and HB4 antennas may be positioned a specified minimum distance away from other high band antennas and/or the LOS1 and LOS2 antennas so that each antenna may operate within its specified minimum RF radiation coverage range. Thus, in this embodiment, each antenna may operate simultaneously at at least a minimum functional level. In some cases, the antennas may be operated in turns (e.g., sequentially or in some other pattern) to allow the antennas to operate at higher power levels without interfering with the performance of the other antennas.

FIG. 6D illustrates an embodiment of a mobile electronic device 600D that may include some or all of the components of device 600C of FIG. 6C, but may also include a 5G1 antenna positioned between the LOS 2 antenna and the HB1 antenna. The mobile electronic device 600D may also include a GNSS antenna positioned between the 5G2 antenna and the HB1 antenna. Still further, the mobile electronic device 600D may include a UHB antenna and a 5G1 antenna positioned between the HB1 and HB3 antennas. Each of these antennas (5G1, 5G2, GNSS, and UHB) may be positioned away from the LOS1 and LOS2 antennas to avoid interfering with those antennas and to reside in a position where simultaneous operation of all antennas may be achieved using at least minimum power levels at each antenna. Mobile electronic device 600E of FIG. 6E may add two FR2 antennas on the top portion of the device when viewed in portrait mode as shown. Mobile electronic device 600F of FIG. 6F may add two low band antennas LB1 and LB2, separated by the communications port 610F, along with other components 621F, 622F, 623F, and others. These components may include cameras, depth sensors, microphones, speakers, indicator lights, buttons, or other electronic or mechanical components. And, mobile electronic device 600G of FIG. 6G may include an alternate positioning of low band antennas LB1 and LB2. In this position, as in FIG. 4H, the LB1 and LB2 antennas may provide orthogonal currents that reduce correlation and, conversely, increase isolation. In such embodiments, other antennas including any or all of those shown in FIG. 4G may be added to the mobile electronic device 600G.

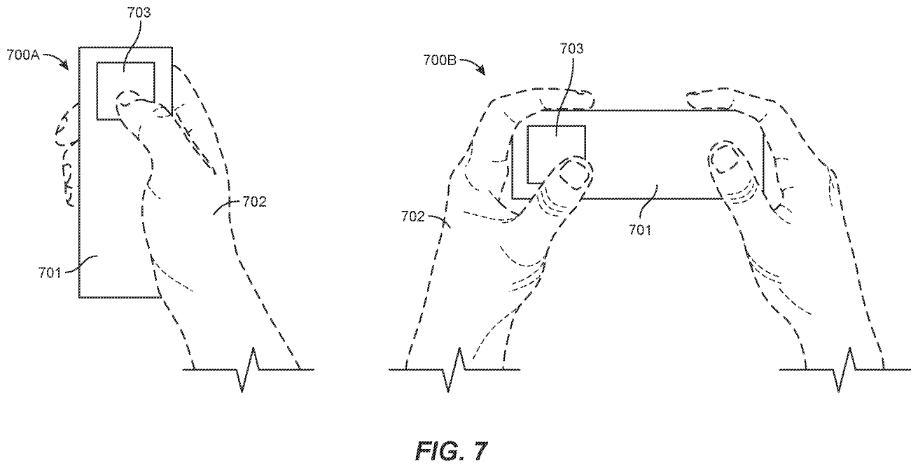

In at least some of the preceding figures, the antennas incorporated in the various mobile electronic device embodiments and the placement of those antennas within the mobile devices was primarily based on positions that would allow each antenna to operate in isolation and would allow the placement of other components. In the embodiments of FIGS. 7-10C, it will be understood that the types of antennas, the placement of antennas, and the use of certain antennas may additionally or alternatively depend on how the mobile device is being used. For instance, as shown in FIG. 7, the mobile electronic device 701 may be held in different ways by a user 702. For example, in embodiment 700A, the user 702 may hold the mobile electronic device 701 in a portrait mode, with the touchpad 703 facing upward. In embodiment 700B, the user 702 may hold the mobile electronic device 701 in a landscape mode, with the touchpad 703 on the left side (as shown) or on the right side. In these different positions, the user's hand or fingers may cover one or more of the antennas shown in FIG. 6F or in other preceding figures. In such cases, alternate antennas may be used.

For example, if the user 702 is holding the mobile electronic device 701 in portrait mode, as in embodiment 700A, the user's hand or thumb may cover the LB1 or HB3 antennas of FIG. 6F. Similarly, in embodiment 700B, the user's left hand may cover the LOS2 antenna, while the user's right hand may cover the LB1 and/or HB3 antennas, along with potentially other antennas. Accordingly, the mobile electronic device 701 may be designed to accommodate such uses by providing multiple antennas of each type, including two or more LOS antennas, positioned on the top and side of the device. In embodiment 700A, for example, either LOS1 or LOS2 may be used, but in embodiment 700B, LOS2 may be occluded and, as such, LOS1 may be used. Similarly, in cases where LB1 or HB3 are potentially occluded by user 702's hand, the LB2, HB4, HB2, HB1, or other antennas may be used in their places.

Accordingly, in different environments, in different use cases, or when being held by different users that hold the devices in different manners, the embodiments herein may turn certain antennas off and use other antennas that are designed to operate in the same frequency range. As the user 702 switches applications and potentially switches how they are holding the device 701, the mobile electronic device 701 may stop transmitting or receiving on certain antennas and may start transmitting or receiving on other antennas that are not being occluded. In some cases, some antennas (e.g., HB1 and HB2) may be primarily transmit antennas, while other antennas (e.g., HB3 and HB4) may be primarily receive antennas. Other configurations are also possible.

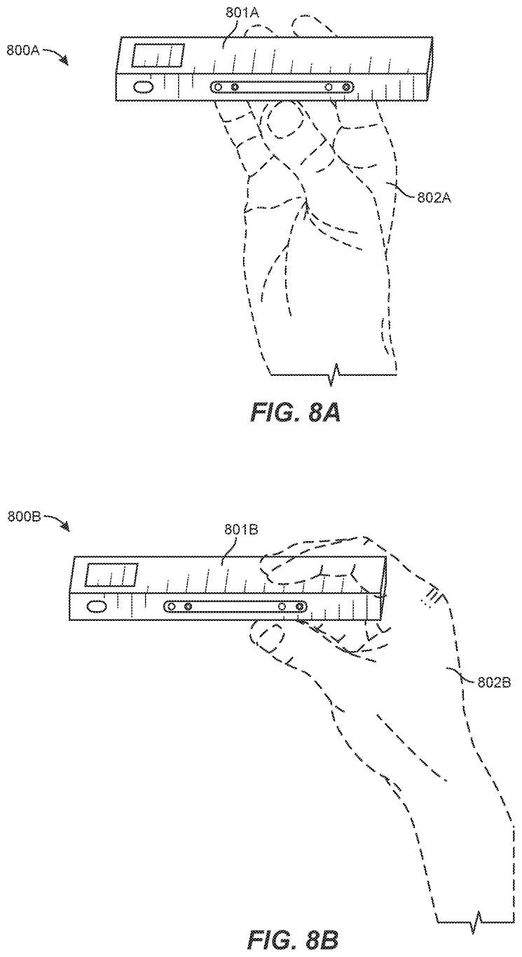

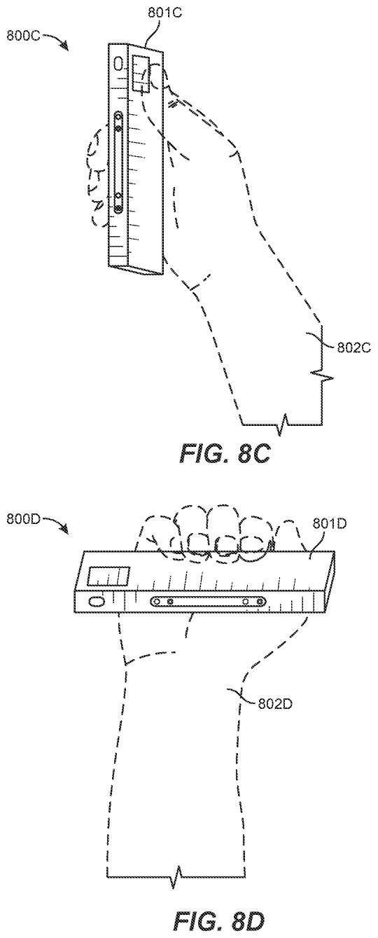

FIGS. 8A-8D illustrate embodiments 800A-800D in which a user 802A-802D may hold the mobile electronic device 801A-801D in different ways. For instance, in embodiment 800A of FIG. 8A, the user 802A may hold the mobile electronic device 801A such that their thumb may at least partially occlude the LOS1 antenna. The user's fingers may also fully or partially occlude other antennas including, for example, HB1, HB3, 5G1, or other antennas. In such cases, the mobile electronic device 801A may be designed to operate using HB2, HB4, 5G2 or other antennas that are not occluded by the user's fingers. Similarly, in embodiment 800B of FIG. 8B, the mobile electronic device 801B may be held in user 802B's hand in a manner that no longer blocks the LOS1 antenna, but may at least partially block LB1, HB3, 5G1, or other antennas. In such cases, the mobile electronic device 801B may be designed to transmit and/or receive data using LB2, HB4, HB2, HB1, 5G2, or other antennas placed on other parts of the device.

FIG. 8C illustrates an embodiment 800C in which a user 802C is holding the mobile electronic device 801C in portrait mode with their thumb over the touchpad. In this embodiment, the user's hand may at least partially cover antennas LB1, HB3, 5G1, UHB, HB1, and/or to topmost FR2 antenna. In such cases, the mobile electronic device 801C may be designed to operate using LOS1, LOS2, LB2, HB4, HB2, the bottommost FR2 antenna, 5G2, or other antennas or combinations of antennas. Still further, embodiment 800D of FIG. 8D illustrates a scenario in which a user 802D may hold the mobile electronic device 801D on the palm of their hand. In such cases, the bottommost FR2 antenna may be occluded, along with HB1, UHB, 5G1, and potentially other antennas. In such scenarios, the mobile electronic device 801D may be designed to operate using LOS1, LOS2, LB1, LB2, HB4, HB2, the topmost FR2 antenna, 5G2, or other antennas. Accordingly, antennas may be positioned to provide redundancy and additional options for transmitting or receiving on various frequency bands when at least some of the antennas are occluded by a user's hand or other object.

FIGS. 9A-9C illustrate embodiments in which LOS and FR2 antennas may be placed in different positions to allow for various handheld positions (e.g., as shown in FIGS. 7-8D). For instance, in FIG. 9A, LOS antennas 901 and 905 may be positioned on top and side portions of a mobile electronic device 900A when viewed in portrait mode. The LOS antennas may be positioned far enough apart to allow each to operate at a minimum power level simultaneously. In FIG. 9A, a first FR2 antenna 902 may be positioned on the top, front-facing portion of the mobile electronic device 900A, while a second FR2 antenna 903 may be positioned on a side portion of the device, opposite of the LOS antenna 905 and to the side of the touchpad 904. The mobile electronic device 900B of FIG. 9B may keep the LOS antennas 901 and 905 in the same positions, while moving the first FR2 antenna 902 to a top, back-facing portion of the device.

The mobile electronic device 900C of FIG. 9C may place the first FR2 antenna 902 on a front-facing portion of the device, may place the second FR2 antenna 903 on the back-facing portion of the device, and may place the first LOS antenna 901 on a side portion of the mobile electronic device 900C, opposite of the second LOS antenna 905. Each of these embodiments may allow different handheld positions, and may use the LOS and FR2 antennas interchangeably. If one LOS/FR2 antenna is blocked or semi-occluded (as determined by signal strength, data transfer rate, dropped packets, error rates, etc.), another LOS/FR2 antenna may be used. In this manner, the mobile electronic devices 900A-900C may change antennas dynamically to ensure that optimal transmission and reception occur regardless of where the user's hands are placed on the devices.

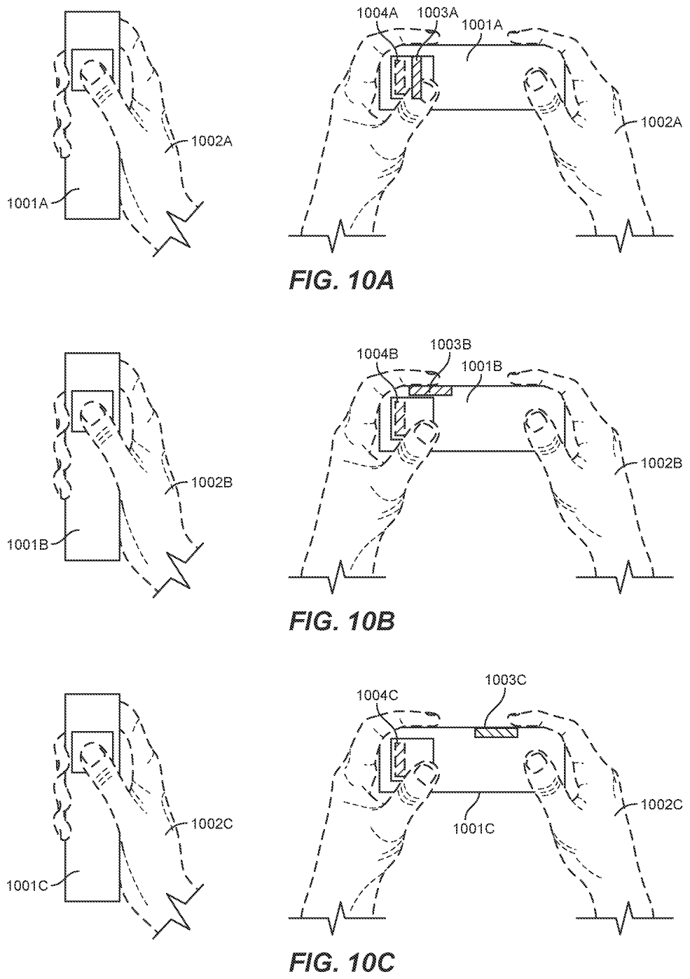

FIGS. 10A-10C illustrate embodiments of a mobile electronic device 1001A-1001C being held by a user 1002A-1002C. The user may hold the mobile electronic device 1001A-1001C with one hand in a portrait manner, or may hold the device with two hands in a landscape manner. In the embodiments of FIGS. 10A-10C, the mobile electronic device 1001A-1001C may include one, two, or more FR2 antennas. These antennas may be placed in different positions and each position may have different levels of operational performance based on where the user's hands are on the device. For instance, in FIG. 10A, a first FR2 antenna 1004A may be placed on a front-facing portion of the mobile electronic device 1001A, and a second FR2 antenna 1003A may be placed on a back-facing portion of the device. In FIG. 10B, the first FR2 antenna 1004B may be placed on the front-facing portion of the mobile electronic device 1001B, while the second FR2 antenna 1003B may be placed on a side portion of the device. In this position, the second FR2 antenna 1003B may not be occluded by the user's thumb (as it is in FIG. 10A), but may at times experience some occlusion by the user's pointer finger. In FIG. 10C, the second FR2 antenna 1003C may be positioned further down along the side of the mobile electronic device 1001C. This may position the second FR2 antenna 1003C away from the first FR2 antenna 1004C and also in a position that may avoid occlusion by the user's right hand. Accordingly, the antennas may be placed in different positions for mobile electronic devices that may experience certain types of use more heavily or for devices that are specifically designed for a specific type of use.

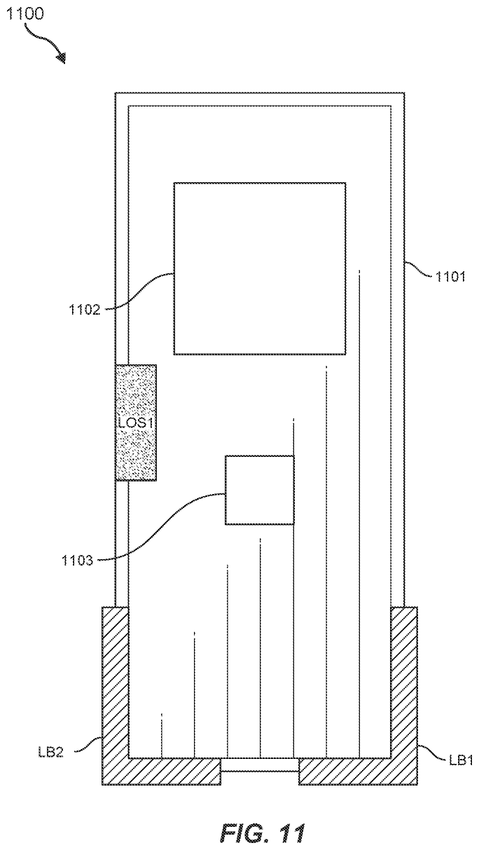

FIG. 11 illustrates an embodiment 1100 that includes a mobile electronic device 1101. The mobile electronic device 1101 may include antennas including a line-of-sight antenna LOS1 and two low band antennas LB1 and LB2, among other antennas. The mobile electronic device 1101 may also include an input button or touchpad 1102 to interact with applications potentially hosted on the mobile electronic device 1101 or on a mobile device that is wirelessly connected to the device 1101. Furthermore, the mobile electronic device 1101 may also include one or multiple ultrawideband (UWB) antennas (e.g., 1103). The UWB antenna 1103 may be placed in a central position on the device 1101. In cases where multiple UWB antennas are used, the UWB antennas may be placed on the sides or top or bottom ends of the device, in addition to placement in the central position. In some embodiments, the UWB antenna 1103 may be placed on a front-facing centered position, as shown in FIG. 11. Because the UWB antenna may be prone to interference from other antennas, it may be placed in a position that is separated from those other antennas, providing the UWB antenna 1103 sufficient space to create a minimum level of spherical radiation coverage. In some embodiments, two or more UWB antennas may be positioned on the support structure of the device 1101 in positions that may substantially avoid interference with LOS antennas, LB antennas, HB antennas, FR1 or FR2 antennas, or other types of antennas that may be implemented within the mobile electronic device 1101.

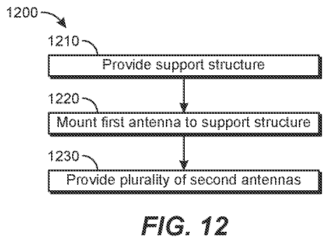

FIG. 12 is a flow diagram of an exemplary computer-implemented method of manufacturing 1200 for manufacturing a mobile electronic device. The steps shown in FIG. 12 may be performed by any suitable computer-executable code and/or computing system, including the systems illustrated and described herein. In one example, each of the steps shown in FIG. 12 may represent an algorithm whose structure includes and/or is represented by multiple sub-steps, examples of which will be provided in greater detail below.

Method of manufacturing 1200 may include, at step 1210, providing a support structure (e.g., 401F of FIG. 4F) that is configured to house various electronic components. These components may include antennas, cameras, sensors, buttons, processors, memory, data storage components, mechanical components, or other features. The method of manufacturing 1200 may next include, at step 1220, mounting a first antenna (e.g., LOS1 (402E)) to the support structure 401F. The LOS1 antenna may be configured to provide a wireless intralink on a specified frequency to a local mobile electronic device (e.g., a smartwatch, a pair of artificial reality glasses, a smartphone, an IoT device, etc.).

The method of manufacturing 1200 may next include, at step 1230, providing one or more second antennas configured to established wireless interlinks on different frequencies to various external wireless networks (e.g., cellular, GNSS, or other external networks). These other antennas may be positioned a specified minimum distance away from the LOS1 antenna. Some of these other antennas may be configured to establish intralinks to local devices. For instance, LB1 and LB2 antennas may establish Bluetooth, WiFi, NFC, or other local intralink connections to local devices. In some cases, the LB1 and LB2 may be positioned at an at least partially opposing angle to each other. As such, the second antennas may provide at least a minimum threshold amount of spherical radiation to transmit and receive data using the established wireless interlinks while limiting correlation between the two low band antennas.

In another embodiment, an alternative method of manufacturing may be provided. In the alternative method of manufacturing, the process may begin by assembling or producing a housing or support structure. The method may next include disposing one or more antenna carriers into the housing. These antenna carriers may include any of the antennas shown in FIG. 6F, for example. The method of manufacturing may then include assembling or producing a front and middle section of the support structure including disposing one or more electronic components thereon. Still further, the method of manufacturing may include disposing a PCB within the housing, electrically connecting one or more components to the PCB, and assembling a back cover onto the device. Thus, the various antenna carriers, electronic components, and PCB(s) may be assembled into a mobile wireless electronic device.

In this manner, the systems, methods, and mobile electronic devices described herein may provide multiple different types of antennas that may operate simultaneously or in an alternate manner. The embodiments herein may include different types of antennas designed to operate in different frequency bands. These antennas may be placed, among other electronic and mechanical components, on various portions of a mobile device's support structure. The placement of these antennas may allow the mobile device to form intralinks and interlinks with many different types of local and remote devices, and may further allow each of these different types of antennas to operate with at least a minimum power level while not interfering with the other surrounding antennas and other components.

### EXAMPLE EMBODIMENTS

Example 1: A system may include: a support structure configured to house one or more electronic components, a first antenna mounted to the support structure, wherein the first antenna is configured to provide a wireless intralink on a first frequency to a local mobile electronic device, and a plurality of second antennas configured to established wireless interlinks on at least a second different frequency to one or more external wireless networks, wherein the second antennas are positioned a specified minimum distance away from the first antenna and are positioned at an at least partially opposing angle to each other, such that the second antennas provide at least a minimum threshold amount of spherical radiation to transmit and receive data using the established wireless interlinks.

Example 2: The system of Example 1, wherein the first antenna establishes a line-of-sight connection to communicate with the local mobile electronic device on the wireless intralink.

Example 3: The system of Example 1 or Example 2, wherein the line-of-sight connection established on the wireless intralink between the first antenna and the local mobile electronic is established using a frequency of at least 53 GHz.

Example 4: The system of any of Examples 1-3, wherein the local mobile electronic device comprises an artificial reality device.

Example 5: The system of any of Examples 1-4, wherein the first antenna is positioned in a front-facing, centered position, and wherein the second antennas are positioned on front-facing and rear-facing positions on a first side of the support structure.

Example 6: The system of any of Examples 1-5, wherein the second antennas comprise low band antennas.

Example 7: The system of any of Examples 1-6, further comprising first and second high band antennas, wherein the first high band antenna is positioned between the first antenna and the front-facing second antenna, and wherein the second high band antenna is positioned on a rear-facing portion of the system between the center of the system and the rear-facing second antenna.

Example 8: The system of any of Examples 1-7, further comprising third and fourth high band antennas, wherein the third high band antenna is positioned between the first antenna and a top portion of the support structure, and wherein the fourth high band antenna is positioned between the second high band antenna and the top portion of the support structure.

Example 9: The system of any of Examples 1-8, further comprising a second intralink antenna that is configured to provide the wireless intralink on the first frequency to the local mobile electronic device.

Example 10: The system of any of Examples 1-9, further comprising a global navigation satellite system (GNSS) antenna positioned on a rear-facing portion of the support structure between the second intralink antenna and a high band antenna.

Example 11: The system of any of Examples 1-10, wherein a front-facing portion of the support structure includes first and second cameras mounted thereto, and wherein the first antenna is positioned between the first and second cameras.

Example 12: The system of any of Examples 1-11, may further include: a third antenna positioned in an upper portion of a side portion of the support structure, and a fourth antenna positioned in a lower portion of the side portion of the support structure.

Example 13: A mobile electronic device may include a support structure configured to house one or more electronic components, a first antenna mounted to the support structure, wherein the first antenna is configured to provide a wireless intralink on a first frequency to a local mobile electronic device, and a plurality of second antennas configured to established wireless interlinks on at least a second different frequency to one or more external wireless networks, wherein the second antennas are positioned a specified minimum distance away from the first antenna and are positioned at an at least partially opposing angle to each other, such that the second antennas provide at least a minimum threshold amount of spherical radiation to transmit and receive data using the established wireless interlinks.

Example 14: The mobile electronic device of Example 13 may further include one or more sensors positioned between the first antenna and at least one of the plurality of second antennas.

Example 15: The mobile electronic device of Example 13 or Example 14, wherein the one or more sensors comprises at least one of a simultaneous location and mapping (SLAM) sensor, a camera, a depth sensor, an inertial motion unit (IMU), an altimeter, a communication port, a touchpad, or an ambient light sensor.

Example 16: The mobile electronic device of any of Examples 13-15, wherein a communication port is positioned between at least two of the plurality of second antennas.

Example 17: The mobile electronic device of any of Examples 13-16, further comprising at least two high band antennas, wherein the at least two high band antennas are offset from each other, such that at least one of the high band antennas remains unoccluded when the mobile electronic device is held in different manners.

Example 18: The mobile electronic device of any of Examples 13-17, wherein the at least two high band antennas comprise third and fourth high band antennas, wherein the third and fourth high band antennas operate as transmission-biased or reception-biased antennas.

Example 19: The mobile electronic device of any of Examples 13-18, further comprising a touchpad positioned on an upper, side portion of the support structure.

Example 20: A method of manufacturing may include providing a support structure configured to house one or more electronic components, mounting a first antenna to the support structure, wherein the first antenna is configured to provide a wireless intralink on a first frequency to a local mobile electronic device, and providing a plurality of second antennas configured to established wireless interlinks on at least a second different frequency to one or more external wireless networks, wherein the second antennas are positioned a specified minimum distance away from the first antenna and are positioned at an at least partially opposing angle to each other, such that the second antennas provide at least a minimum threshold amount of spherical radiation to transmit and receive data using the established wireless interlinks.

Embodiments of the present disclosure may include or be implemented in conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

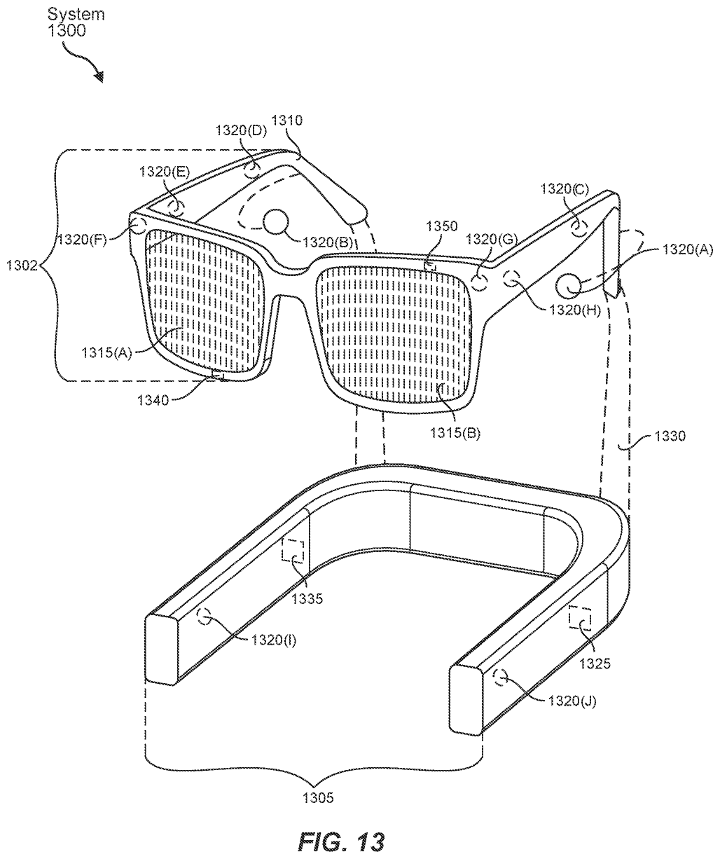

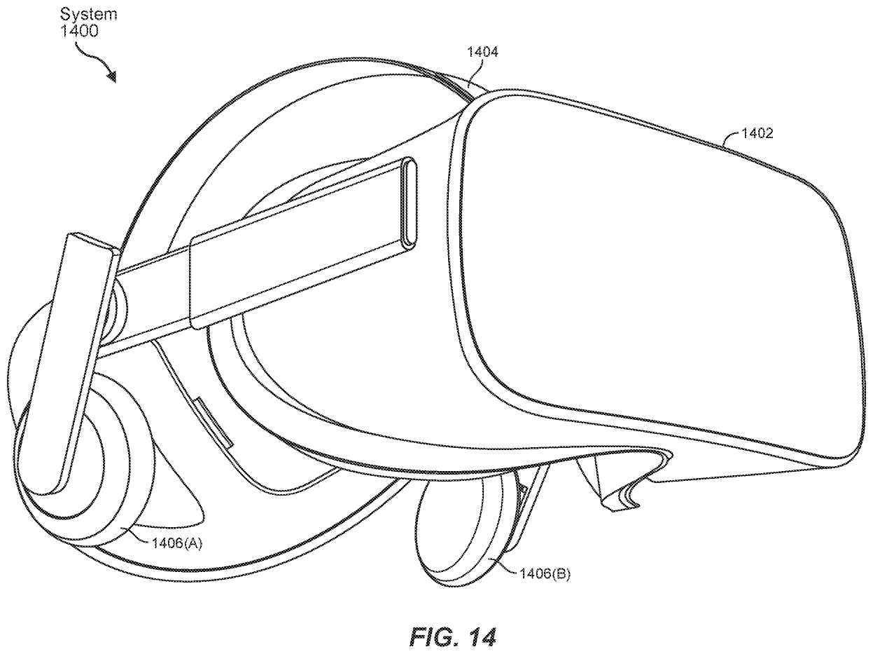

Artificial-reality systems may be implemented in a variety of different form factors and configurations. Some artificial-reality systems may be designed to work without near-eye displays (NEDs). Other artificial-reality systems may include an NED that also provides visibility into the real world (such as, e.g., augmented-reality system 1300 in FIG. 13) or that visually immerses a user in an artificial reality (such as, e.g., virtual-reality system 1400 in FIG. 14). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 13, augmented-reality system 1300 may include an eyewear device 1302 with a frame 1310 configured to hold a left display device 1315(A) and a right display device 1315(B) in front of a user's eyes. Display devices 1315(A) and 1315(B) may act together or independently to present an image or series of images to a user. While augmented-reality system 1300 includes two displays, embodiments of this disclosure may be implemented in augmented-reality systems with a single NED or more than two NEDs.

In some embodiments, augmented-reality system 1300 may include one or more sensors, such as sensor 1340. Sensor 1340 may generate measurement signals in response to motion of augmented-reality system 1300 and may be located on substantially any portion of frame 1310. Sensor 1340 may represent one or more of a variety of different sensing mechanisms, such as a position sensor, an inertial measurement unit (IMU), a depth camera assembly, a structured light emitter and/or detector, or any combination thereof. In some embodiments, augmented-reality system 1300 may or may not include sensor 1340 or may include more than one sensor. In embodiments in which sensor 1340 includes an IMU, the IMU may generate calibration data based on measurement signals from sensor 1340. Examples of sensor 1340 may include, without limitation, accelerometers, gyroscopes, magnetometers, other suitable types of sensors that detect motion, sensors used for error correction of the IMU, or some combination thereof.

In some examples, augmented-reality system 1300 may also include a microphone array with a plurality of acoustic transducers 1320(A)-1320(J), referred to collectively as acoustic transducers 1320. Acoustic transducers 1320 may represent transducers that detect air pressure variations induced by sound waves. Each acoustic transducer 1320 may be configured to detect sound and convert the detected sound into an electronic format (e.g., an analog or digital format). The microphone array in FIG. 13 may include, for example, ten acoustic transducers: 1320(A) and 1320(B), which may be designed to be placed inside a corresponding ear of the user, acoustic transducers 1320(C), 1320(D), 1320(E), 1320(F), 1320(G), and 1320(H), which may be positioned at various locations on frame 1310, and/or acoustic transducers 1320(1) and 1320(J), which may be positioned on a corresponding neckband 1305.

In some embodiments, one or more of acoustic transducers 1320(A)-(J) may be used as output transducers (e.g., speakers). For example, acoustic transducers 1320(A) and/or 1320(B) may be earbuds or any other suitable type of headphone or speaker.

The configuration of acoustic transducers 1320 of the microphone array may vary. While augmented-reality system 1300 is shown in FIG. 13 as having ten acoustic transducers 1320, the number of acoustic transducers 1320 may be greater or less than ten. In some embodiments, using higher numbers of acoustic transducers 1320 may increase the amount of audio information collected and/or the sensitivity and accuracy of the audio information. In contrast, using a lower number of acoustic transducers 1320 may decrease the computing power required by an associated controller 1350 to process the collected audio information. In addition, the position of each acoustic transducer 1320 of the microphone array may vary. For example, the position of an acoustic transducer 1320 may include a defined position on the user, a defined coordinate on frame 1310, an orientation associated with each acoustic transducer 1320, or some combination thereof.

Acoustic transducers 1320(A) and 1320(B) may be positioned on different parts of the user's ear, such as behind the pinna, behind the tragus, and/or within the auricle or fossa. Or, there may be additional acoustic transducers 1320 on or surrounding the ear in addition to acoustic transducers 1320 inside the ear canal. Having an acoustic transducer 1320 positioned next to an ear canal of a user may enable the microphone array to collect information on how sounds arrive at the ear canal. By positioning at least two of acoustic transducers 1320 on either side of a user's head (e.g., as binaural microphones), augmented-reality device 1300 may simulate binaural hearing and capture a 3D stereo sound field around about a user's head. In some embodiments, acoustic transducers 1320(A) and 1320(B) may be connected to augmented-reality system 1300 via a wired connection 1330, and in other embodiments acoustic transducers 1320(A) and 1320(B) may be connected to augmented-reality system 1300 via a wireless connection (e.g., a BLUETOOTH connection). In still other embodiments, acoustic transducers 1320(A) and 1320(B) may not be used at all in conjunction with augmented-reality system 1300.

Acoustic transducers 1320 on frame 1310 may be positioned in a variety of different ways, including along the length of the temples, across the bridge, above or below display devices 1315(A) and 1315(B), or some combination thereof. Acoustic transducers 1320 may also be oriented such that the microphone array is able to detect sounds in a wide range of directions surrounding the user wearing the augmented-reality system 1300. In some embodiments, an optimization process may be performed during manufacturing of augmented-reality system 1300 to determine relative positioning of each acoustic transducer 1320 in the microphone array.

In some examples, augmented-reality system 1300 may include or be connected to an external device (e.g., a paired device), such as neckband 1305. Neckband 1305 generally represents any type or form of paired device. Thus, the following discussion of neckband 1305 may also apply to various other paired devices, such as charging cases, smart watches, smart phones, wrist bands, other wearable devices, hand-held controllers, tablet computers, laptop computers, other external compute devices, etc.

As shown, neckband 1305 may be coupled to eyewear device 1302 via one or more connectors. The connectors may be wired or wireless and may include electrical and/or non-electrical (e.g., structural) components. In some cases, eyewear device 1302 and neckband 1305 may operate independently without any wired or wireless connection between them. While FIG. 13 illustrates the components of eyewear device 1302 and neckband 1305 in example locations on eyewear device 1302 and neckband 1305, the components may be located elsewhere and/or distributed differently on eyewear device 1302 and/or neckband 1305. In some embodiments, the components of eyewear device 1302 and neckband 1305 may be located on one or more additional peripheral devices paired with eyewear device 1302, neckband 1305, or some combination thereof.

Pairing external devices, such as neckband 1305, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 1300 may be provided by a paired device or shared between a paired device and an eyewear device, thus reducing the weight, heat profile, and form factor of the eyewear device overall while still retaining desired functionality. For example, neckband 1305 may allow components that would otherwise be included on an eyewear device to be included in neckband 1305 since users may tolerate a heavier weight load on their shoulders than they would tolerate on their heads. Neckband 1305 may also have a larger surface area over which to diffuse and disperse heat to the ambient environment. Thus, neckband 1305 may allow for greater battery and computation capacity than might otherwise have been possible on a stand-alone eyewear device. Since weight carried in neckband 1305 may be less invasive to a user than weight carried in eyewear device 1302, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 1305 may be communicatively coupled with eyewear device 1302 and/or to other devices. These other devices may provide certain functions (e.g., tracking, localizing, depth mapping, processing, storage, etc.) to augmented-reality system 1300. In the embodiment of FIG. 13, neckband 1305 may include two acoustic transducers (e.g., 1320(1) and 1320(J)) that are part of the microphone array (or potentially form their own microphone subarray). Neckband 1305 may also include a controller 1325 and a power source 1335.

Acoustic transducers 1320(1) and 1320(J) of neckband 1305 may be configured to detect sound and convert the detected sound into an electronic format (analog or digital). In the embodiment of FIG. 13, acoustic transducers 1320(1) and 1320(J) may be positioned on neckband 1305, thereby increasing the distance between the neckband acoustic transducers 1320(1) and 1320(J) and other acoustic transducers 1320 positioned on eyewear device 1302. In some cases, increasing the distance between acoustic transducers 1320 of the microphone array may improve the accuracy of beamforming performed via the microphone array. For example, if a sound is detected by acoustic transducers 1320(C) and 1320(D) and the distance between acoustic transducers 1320(C) and 1320(D) is greater than, e.g., the distance between acoustic transducers 1320(D) and 1320(E), the determined source location of the detected sound may be more accurate than if the sound had been detected by acoustic transducers 1320(D) and 1320(E).

Controller 1325 of neckband 1305 may process information generated by the sensors on neckband 1305 and/or augmented-reality system 1300. For example, controller 1325 may process information from the microphone array that describes sounds detected by the microphone array. For each detected sound, controller 1325 may perform a direction-of-arrival (DOA) estimation to estimate a direction from which the detected sound arrived at the microphone array. As the microphone array detects sounds, controller 1325 may populate an audio data set with the information. In embodiments in which augmented-reality system 1300 includes an inertial measurement unit, controller 1325 may compute all inertial and spatial calculations from the IMU located on eyewear device 1302. A connector may convey information between augmented-reality system 1300 and neckband 1305 and between augmented-reality system 1300 and controller 1325. The information may be in the form of optical data, electrical data, wireless data, or any other transmittable data form. Moving the processing of information generated by augmented-reality system 1300 to neckband 1305 may reduce weight and heat in eyewear device 1302, making it more comfortable to the user.

Power source 1335 in neckband 1305 may provide power to eyewear device 1302 and/or to neckband 1305. Power source 1335 may include, without limitation, lithium ion batteries, lithium-polymer batteries, primary lithium batteries, alkaline batteries, or any other form of power storage. In some cases, power source 1335 may be a wired power source. Including power source 1335 on neckband 1305 instead of on eyewear device 1302 may help better distribute the weight and heat generated by power source 1335.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 1400 in FIG. 14, that mostly or completely covers a user's field of view. Virtual-reality system 1400 may include a front rigid body 1402 and a band 1404 shaped to fit around a user's head. Virtual-reality system 1400 may also include output audio transducers 1406(A) and 1406(B). Furthermore, while not shown in FIG. 14, front rigid body 1402 may include one or more electronic elements, including one or more electronic displays, one or more inertial measurement units (IMUS), one or more tracking emitters or detectors, and/or any other suitable device or system for creating an artificial-reality experience.

Artificial-reality systems may include a variety of types of visual feedback mechanisms. For example, display devices in augmented-reality system 1300 and/or virtual-reality system 1400 may include one or more liquid crystal displays (LCDs), light emitting diode (LED) displays, microLED displays, organic LED (OLED) displays, digital light project (DLP) micro-displays, liquid crystal on silicon (LCoS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in augmented-reality system 1300 and/or virtual-reality system 1400 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, augmented-reality system 1300 and/or virtual-reality system 1400 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

As noted, artificial-reality systems 1300 and 1400 may be used with a variety of other types of devices to provide a more compelling artificial-reality experience. These devices may be haptic interfaces with transducers that provide haptic feedback and/or that collect haptic information about a user's interaction with an environment. The artificial-reality systems disclosed herein may include various types of haptic interfaces that detect or convey various types of haptic information, including tactile feedback (e.g., feedback that a user detects via nerves in the skin, which may also be referred to as cutaneous feedback) and/or kinesthetic feedback (e.g., feedback that a user detects via receptors located in muscles, joints, and/or tendons).

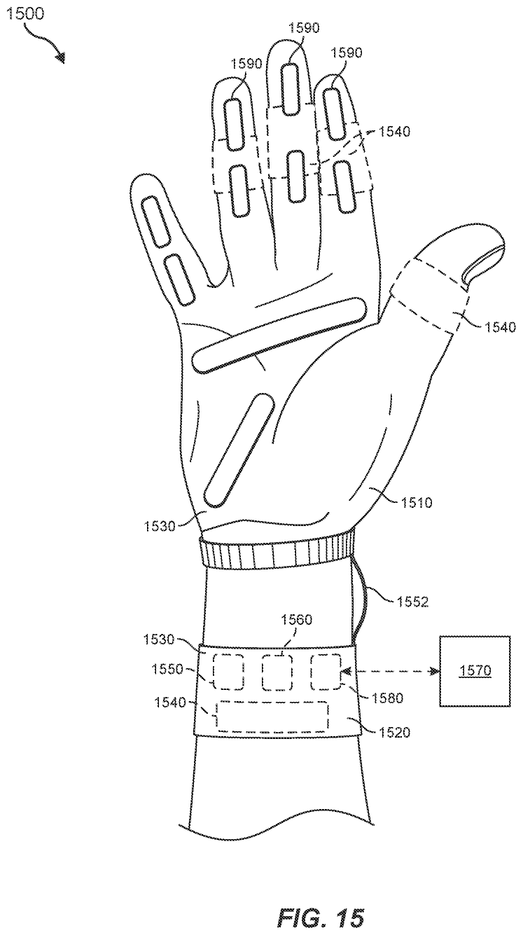

Haptic feedback may be provided by interfaces positioned within a user's environment (e.g., chairs, tables, floors, etc.) and/or interfaces on articles that may be worn or carried by a user (e.g., gloves, wristbands, etc.). As an example, FIG. 15 illustrates a vibrotactile system 1500 in the form of a wearable glove (haptic device 1510) and wristband (haptic device 1520). Haptic device 1510 and haptic device 1520 are shown as examples of wearable devices that include a flexible, wearable textile material 1530 that is shaped and configured for positioning against a user's hand and wrist, respectively. This disclosure also includes vibrotactile systems that may be shaped and configured for positioning against other human body parts, such as a finger, an arm, a head, a torso, a foot, or a leg. By way of example and not limitation, vibrotactile systems according to various embodiments of the present disclosure may also be in the form of a glove, a headband, an armband, a sleeve, a head covering, a sock, a shirt, or pants, among other possibilities. In some examples, the term “textile” may include any flexible, wearable material, including woven fabric, non-woven fabric, leather, cloth, a flexible polymer material, composite materials, etc.

One or more vibrotactile devices 1540 may be positioned at least partially within one or more corresponding pockets formed in textile material 1530 of vibrotactile system 1500. Vibrotactile devices 1540 may be positioned in locations to provide a vibrating sensation (e.g., haptic feedback) to a user of vibrotactile system 1500. For example, vibrotactile devices 1540 may be positioned against the user's finger(s), thumb, or wrist, as shown in FIG. 15. Vibrotactile devices 1540 may, in some examples, be sufficiently flexible to conform to or bend with the user's corresponding body part(s).

A power source 1550 (e.g., a battery) for applying a voltage to the vibrotactile devices 1540 for activation thereof may be electrically coupled to vibrotactile devices 1540, such as via conductive wiring 1552. In some examples, each of vibrotactile devices 1540 may be independently electrically coupled to power source 1550 for individual activation. In some embodiments, a processor 1560 may be operatively coupled to power source 1550 and configured (e.g., programmed) to control activation of vibrotactile devices 1540.

Vibrotactile system 1500 may be implemented in a variety of ways. In some examples, vibrotactile system 1500 may be a standalone system with integral subsystems and components for operation independent of other devices and systems. As another example, vibrotactile system 1500 may be configured for interaction with another device or system 1570. For example, vibrotactile system 1500 may, in some examples, include a communications interface 1580 for receiving and/or sending signals to the other device or system 1570. The other device or system 1570 may be a mobile device, a gaming console, an artificial-reality (e.g., virtual-reality, augmented-reality, mixed-reality) device, a personal computer, a tablet computer, a network device (e.g., a modem, a router, etc.), a handheld controller, etc. Communications interface 1580 may enable communications between vibrotactile system 1500 and the other device or system 1570 via a wireless (e.g., Wi-Fi, BLUETOOTH, cellular, radio, etc.) link or a wired link. If present, communications interface 1580 may be in communication with processor 1560, such as to provide a signal to processor 1560 to activate or deactivate one or more of the vibrotactile devices 1540.

Vibrotactile system 1500 may optionally include other subsystems and components, such as touch-sensitive pads 1590, pressure sensors, motion sensors, position sensors, lighting elements, and/or user interface elements (e.g., an on/off button, a vibration control element, etc.). During use, vibrotactile devices 1540 may be configured to be activated for a variety of different reasons, such as in response to the user's interaction with user interface elements, a signal from the motion or position sensors, a signal from the touch-sensitive pads 1590, a signal from the pressure sensors, a signal from the other device or system 1570, etc.

Although power source 1550, processor 1560, and communications interface 1580 are illustrated in FIG. 15 as being positioned in haptic device 1520, the present disclosure is not so limited. For example, one or more of power source 1550, processor 1560, or communications interface 1580 may be positioned within haptic device 1510 or within another wearable textile.

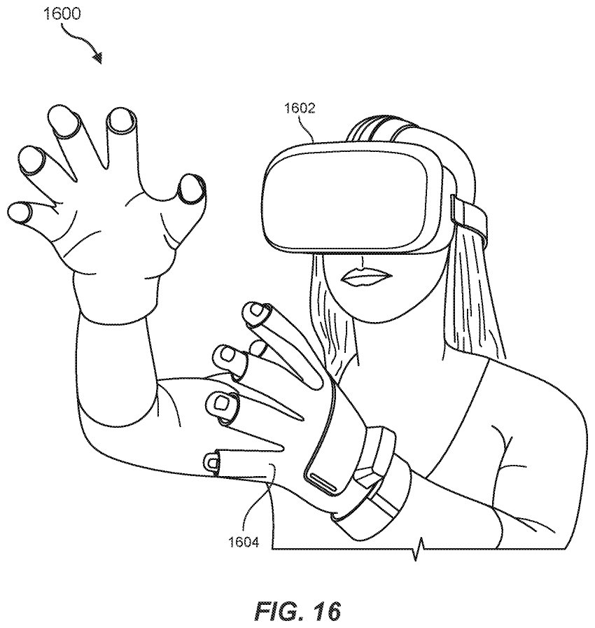

Haptic wearables, such as those shown in and described in connection with FIG. 15, may be implemented in a variety of types of artificial-reality systems and environments. FIG. 16 shows an example artificial-reality environment 1600 including one head-mounted virtual-reality display and two haptic devices (i.e., gloves), and in other embodiments any number and/or combination of these components and other components may be included in an artificial-reality system. For example, in some embodiments there may be multiple head-mounted displays each having an associated haptic device, with each head-mounted display and each haptic device communicating with the same console, portable computing device, or other computing system.

Head-mounted display 1602 generally represents any type or form of virtual-reality system, such as virtual-reality system 1400 in FIG. 14. Haptic device 1604 generally represents any type or form of wearable device, worn by a user of an artificial-reality system, that provides haptic feedback to the user to give the user the perception that he or she is physically engaging with a virtual object. In some embodiments, haptic device 1604 may provide haptic feedback by applying vibration, motion, and/or force to the user. For example, haptic device 1604 may limit or augment a user's movement. To give a specific example, haptic device 1604 may limit a user's hand from moving forward so that the user has the perception that his or her hand has come in physical contact with a virtual wall. In this specific example, one or more actuators within the haptic device may achieve the physical-movement restriction by pumping fluid into an inflatable bladder of the haptic device. In some examples, a user may also use haptic device 1604 to send action requests to a console. Examples of action requests include, without limitation, requests to start an application and/or end the application and/or requests to perform a particular action within the application.

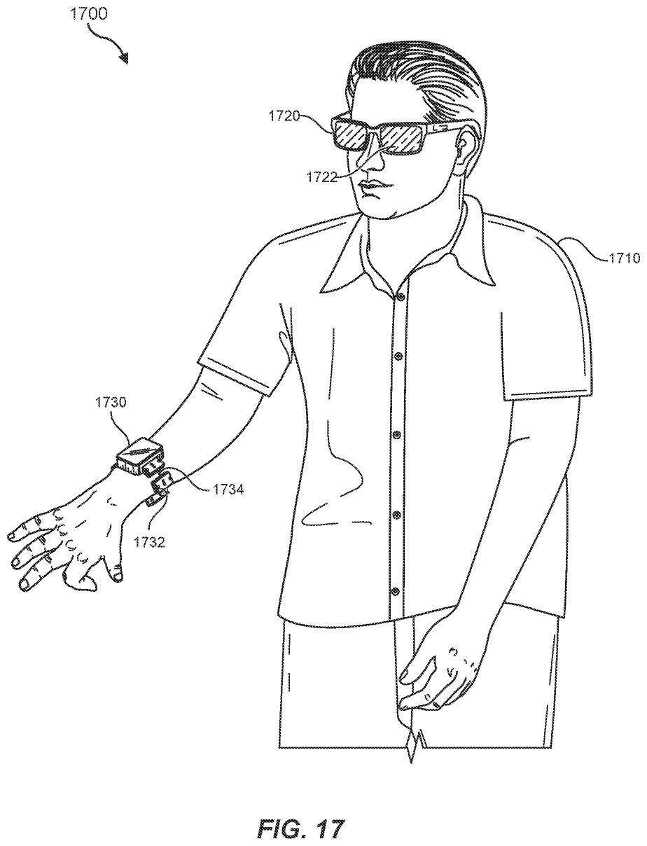

While haptic interfaces may be used with virtual-reality systems, as shown in FIG. 16, haptic interfaces may also be used with augmented-reality systems, as shown in FIG. 17. FIG. 17 is a perspective view of a user 1710 interacting with an augmented-reality system 1700. In this example, user 1710 may wear a pair of augmented-reality glasses 1720 that may have one or more displays 1722 and that are paired with a haptic device 1730. In this example, haptic device 1730 may be a wristband that includes a plurality of band elements 1732 and a tensioning mechanism 1734 that connects band elements 1732 to one another.

One or more of band elements 1732 may include any type or form of actuator suitable for providing haptic feedback. For example, one or more of band elements 1732 may be configured to provide one or more of various types of cutaneous feedback, including vibration, force, traction, texture, and/or temperature. To provide such feedback, band elements 1732 may include one or more of various types of actuators. In one example, each of band elements 1732 may include a vibrotactor (e.g., a vibrotactile actuator) configured to vibrate in unison or independently to provide one or more of various types of haptic sensations to a user. Alternatively, only a single band element or a subset of band elements may include vibrotactors.

Haptic devices 1510, 1520, 1604, and 1730 may include any suitable number and/or type of haptic transducer, sensor, and/or feedback mechanism. For example, haptic devices 1510, 1520, 1604, and 1730 may include one or more mechanical transducers, piezoelectric transducers, and/or fluidic transducers. Haptic devices 1510, 1520, 1604, and 1730 may also include various combinations of different types and forms of transducers that work together or independently to enhance a user's artificial-reality experience. In one example, each of band elements 1732 of haptic device 1730 may include a vibrotactor (e.g., a vibrotactile actuator) configured to vibrate in unison or independently to provide one or more of various types of haptic sensations to a user.

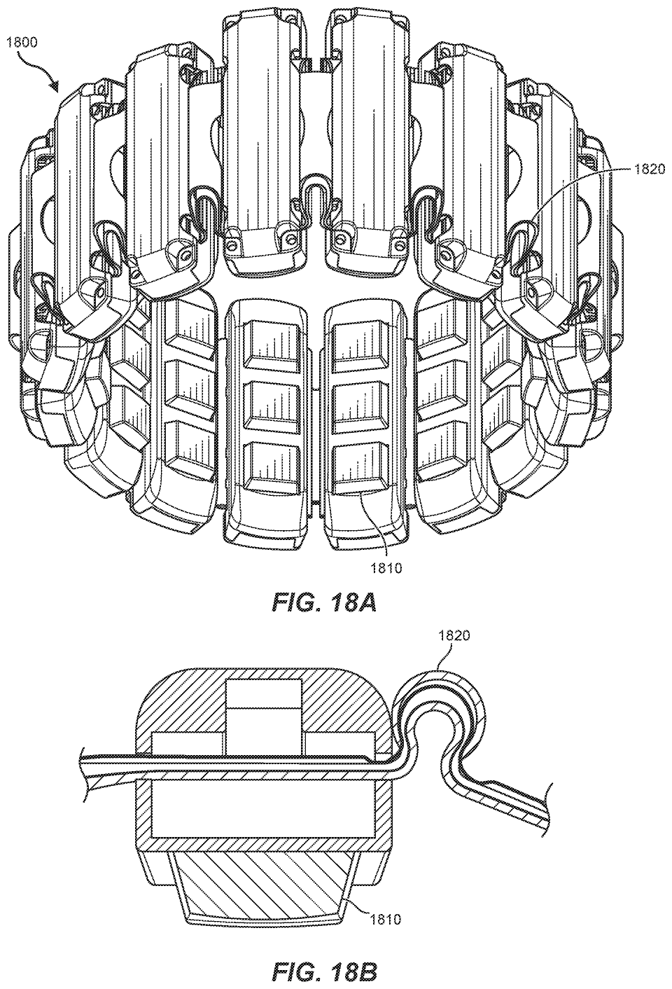

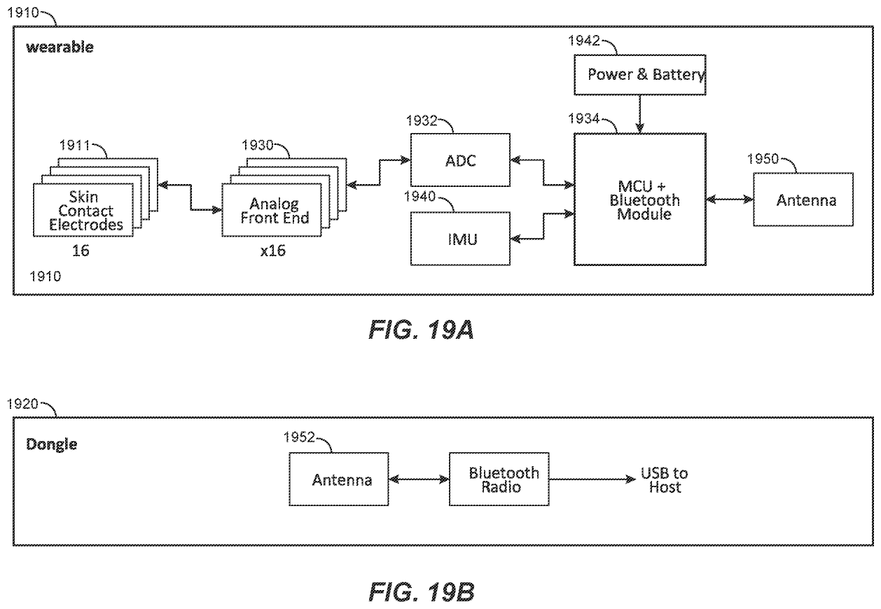

FIG. 18A illustrates an exemplary human-machine interface (also referred to herein as an EMG control interface) configured to be worn around a user's lower arm or wrist as a wearable system 1800. In this example, wearable system 1800 may include sixteen neuromuscular sensors 1810 (e.g., EMG sensors) arranged circumferentially around an elastic band 1820 with an interior surface configured to contact a user's skin. However, any suitable number of neuromuscular sensors may be used. The number and arrangement of neuromuscular sensors may depend on the particular application for which the wearable device is used. For example, a wearable armband or wristband can be used to generate control information for controlling an augmented reality system, a robot, controlling a vehicle, scrolling through text, controlling a virtual avatar, or any other suitable control task. As shown, the sensors may be coupled together using flexible electronics incorporated into the wireless device. FIG. 18B illustrates a cross-sectional view through one of the sensors of the wearable device shown in FIG. 18A. In some embodiments, the output of one or more of the sensing components can be optionally processed using hardware signal processing circuitry (e.g., to perform amplification, filtering, and/or rectification). In other embodiments, at least some signal processing of the output of the sensing components can be performed in software. Thus, signal processing of signals sampled by the sensors can be performed in hardware, software, or by any suitable combination of hardware and software, as aspects of the technology described herein are not limited in this respect. A non-limiting example of a signal processing chain used to process recorded data from sensors 1810 is discussed in more detail below with reference to FIGS. 19A and 19B.

FIGS. 19A and 19B illustrate an exemplary schematic diagram with internal components of a wearable system with EMG sensors. As shown, the wearable system may include a wearable portion 1910 (FIG. 19A) and a dongle portion 1920 (FIG. 19B) in communication with the wearable portion 1910 (e.g., via BLUETOOTH or another suitable wireless communication technology). As shown in FIG. 19A, the wearable portion 1910 may include skin contact electrodes 1911, examples of which are described in connection with FIGS. 18A and 18B. The output of the skin contact electrodes 1911 may be provided to analog front end 1930, which may be configured to perform analog processing (e.g., amplification, noise reduction, filtering, etc.) on the recorded signals. The processed analog signals may then be provided to analog-to-digital converter 1932, which may convert the analog signals to digital signals that can be processed by one or more computer processors. An example of a computer processor that may be used in accordance with some embodiments is microcontroller (MCU) 1934, illustrated in FIG. 19A. As shown, MCU 1934 may also include inputs from other sensors (e.g., IMU sensor 1940), and power and battery module 1942. The output of the processing performed by MCU 1934 may be provided to antenna 1950 for transmission to dongle portion 1920 shown in FIG. 19B.

Dongle portion 1920 may include antenna 1952, which may be configured to communicate with antenna 1950 included as part of wearable portion 1910. Communication between antennas 1950 and 1952 may occur using any suitable wireless technology and protocol, non-limiting examples of which include radiofrequency signaling and BLUETOOTH. As shown, the signals received by antenna 1952 of dongle portion 1920 may be provided to a host computer for further processing, display, and/or for effecting control of a particular physical or virtual object or objects.

Although the examples provided with reference to FIGS. 18A-18B and FIGS. 19A-19B are discussed in the context of interfaces with EMG sensors, the techniques described herein for reducing electromagnetic interference can also be implemented in wearable interfaces with other types of sensors including, but not limited to, mechanomyography (MMG) sensors, sonomyography (SMG) sensors, and electrical impedance tomography (EIT) sensors. The techniques described herein for reducing electromagnetic interference can also be implemented in wearable interfaces that communicate with computer hosts through wires and cables (e.g., USB cables, optical fiber cables, etc.).

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive data to be transformed, transform the data, output a result of the transformation, and store the result of the transformation. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A system comprising:
a support structure configured to house one or more electronic components;
a first antenna mounted to the support structure, wherein the first antenna is configured to provide a wireless intralink on a first frequency to a local mobile electronic device; and
a plurality of second antennas configured to established wireless interlinks on at least a second different frequency to one or more external wireless networks,
wherein the second antennas are positioned a specified minimum distance away from the first antenna and are positioned at an at least partially opposing angle to each other, such that the second antennas provide at least a minimum threshold amount of spherical radiation to transmit and receive data using the established wireless interlinks.

2. The system of claim 1, wherein the first antenna establishes a line-of-sight connection to communicate with the local mobile electronic device on the wireless intralink.

3. The system of claim 2, wherein the line-of-sight connection established on the wireless intralink between the first antenna and the local mobile electronic is established using a frequency of at least 53 GHz.

4. The system of claim 1, wherein the local mobile electronic device comprises an artificial reality device.

5. The system of claim 1, wherein the first antenna is positioned in a front-facing, centered position, and wherein the second antennas are positioned in front-facing and rear-facing positions on a first side of the support structure.

6. The system of claim 5, wherein the second antennas comprise low band antennas.

7. The system of claim 5, further comprising first and second high band antennas, wherein the first high band antenna is positioned between the first antenna and a front-facing second antenna, and wherein the second high band antenna is positioned on a rear-facing portion of the system between the center of the system and a rear-facing second antenna.

8. The system of claim 7, further comprising third and fourth high band antennas, wherein the third high band antenna is positioned between the first antenna and a top portion of the support structure, and wherein the fourth high band antenna is positioned between the second high band antenna and the top portion of the support structure.

9. The system of claim 5, further comprising a second intralink antenna that is configured to provide the wireless intralink on the first frequency to the local mobile electronic device.

10. The system of claim 9, further comprising a global navigation satellite system (GNSS) antenna positioned on a rear-facing portion of the support structure between the second intralink antenna and a high band antenna.

11. The system of claim 1, wherein a front-facing portion of the support structure includes first and second cameras mounted thereto, and wherein the first antenna is positioned between the first and second cameras.

12. The system of claim 1, further comprising:
a third antenna positioned in an upper portion of a side portion of the support structure; and
a fourth antenna positioned in a lower portion of the side portion of the support structure.

13. A mobile electronic device, comprising:
a support structure configured to house one or more electronic components;
a first antenna mounted to the support structure, wherein the first antenna is configured to provide a wireless intralink on a first frequency to a local mobile electronic device; and
a plurality of second antennas configured to established wireless interlinks on at least a second different frequency to one or more external wireless networks,
wherein the second antennas are positioned a specified minimum distance away from the first antenna and are positioned at an at least partially opposing angle to each other, such that the second antennas provide at least a minimum threshold amount of spherical radiation to transmit and receive data using the established wireless interlinks.

14. The mobile electronic device of claim 13, further comprising one or more sensors positioned between the first antenna and at least one of the plurality of second antennas.

15. The mobile electronic device of claim 14, wherein the one or more sensors comprises at least one of a simultaneous location and mapping (SLAM) sensor, a camera, a depth sensor, an inertial motion unit (IMU), an altimeter, a communication port, a touchpad, or an ambient light sensor.

16. The mobile electronic device of claim 13, wherein a communication port is positioned between at least two of the plurality of second antennas.

17. The mobile electronic device of claim 13, further comprising at least two high band antennas, wherein the at least two high band antennas are offset from each other, such that at least one of the high band antennas remains unoccluded when the mobile electronic device is held in different manners.

18. The mobile electronic device of claim 17, wherein the at least two high band antennas comprise third and fourth high band antennas, wherein the third and fourth high band antennas operate as transmission-biased or reception-biased antennas.

19. The mobile electronic device of claim 13, further comprising a touchpad positioned on an upper, side portion of the support structure.

20. A method of manufacturing, comprising:
providing a support structure configured to house one or more electronic components;
mounting a first antenna to the support structure, wherein the first antenna is configured to provide a wireless intralink on a first frequency to a local mobile electronic device; and
providing a plurality of second antennas configured to established wireless interlinks on at least a second different frequency to one or more external wireless networks,
wherein the second antennas are positioned a specified minimum distance away from the first antenna and are positioned at an at least partially opposing angle to each other, such that the second antennas provide at least a minimum threshold amount of spherical radiation to transmit and receive data using the established wireless interlinks.
